(19) United States
(12) Patent Application Publication
(10) Pub. No.: US 2024/0388345 A1
(43) Pub. Date: Nov. 21, 2024

(54) METHOD AND APPARATUS FOR ENERGY SAVING IN WIRELESS COMMUNICATION SYSTEM

(71) Applicant: Samsung Electronics Co., Ltd., Gyeonggi-do (KR)

(72) Inventors: Junyung YI, Gyeonggi-do (KR); Youngbum KIM, Gyeonggi-do (KR); Younsun KIM, Gyeonggi-do (KR); Youngrok JANG, Gyeonggi-do (KR)

(21) Appl. No.: 18/663,705

(22) Filed: May 14, 2024

(30) Foreign Application Priority Data
May 15, 2023 (KR) 10-2023-0062605
Jul. 28, 2023 (KR) 10-2023-0099081

(51) Int. Cl. H04B 7/06; H04W 72/1268

(52) U.S. Cl. CPC H04B 7/0626; H04B 7/063; H04W 72/1268

(57) ABSTRACT

The disclosure relates to a fifth generation (5G) or sixth generation (6G) communication system for supporting a higher data transmission rate. A control signal processing method in a wireless communication system of the disclosure includes receiving a first control signal transmitted from a base station, processing the received first control signal, and transmitting, to the base station, a second control signal generated based on the processing.

### CROSS REFERENCE TO RELATED APPLICATION(S)

This application is based on and claims priority under 35 U.S.C. § 119 to Korean Patent Application Nos. 10-2023-0062605 and 10-2023-0099081, which were filed in the Korean Intellectual Property Office on May 15, 2023, and Jul. 28, 2023, respectively, the disclosures of which are incorporated herein by reference in their entireties.

### BACKGROUND

### 1. Field

The disclosure relates generally to operations of a terminal and a base station in a wireless communication system and, specifically, to a method and an apparatus for energy saving in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement sixth generation (6G) mobile communication technologies (referred to as beyond 5G systems) in terahertz (THz) bands (for example, 95 GHz to 3 THz bands) to achieve transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Discussions persist regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional multiple input multiple output (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the development of a 5G/6G communication system in consideration of the recent environment, there is a need in the art for a method for reducing energy consumption of a communication system (e.g., a terminal, a base station, a network, etc.) and for energy saving in the communication system.

### SUMMARY

The disclosure has been made to address at least the above-mentioned problems and/or disadvantages and to provide at least the advantages described below.

Accordingly, an aspect of the disclosure is to provide a priority determination method and a multiplexing method of CSI reports of a terminal for determining spatial domain adaptation (SD) and power domain adaptation (PD) to reduce the energy consumption of the base station in a wireless communication system.

An aspect of the disclosure is to provide an SD adaptation method for turning off spatial and power elements (e.g., including one or more of an antenna element (AE), a power amplifier (PA), an antenna port, or an antenna panel) of the base station for energy saving of the base station.

An aspect of the disclosure is to provide an efficient CSI resource and CSI resource set configuration and CSI report configuration method through higher-layer signaling (e.g., radio resource control (RRC) signaling) for applying SD adaptation.

An aspect of the disclosure is to provide a method for determining the priorities between CSI reports, based on information configured for network energy saving (NES), and a multiplexing method for transmitting multiple CSI reports in a physical uplink control channel (PUCCH) or a physical uplink shared channel (PUSCH). To this end, the base station may receive an appropriate CSI report during SD and PD adaptation for energy saving.

In accordance with an aspect of the disclosure, a control signal processing method in a wireless communication system includes receiving a first control signal transmitted from a base station, processing the received first control signal, generating a second signal based on the processing, and transmitting the generated second control signal to the base station.

In accordance with an aspect of the disclosure, a multi-CSI report priority determination method and a multi-CSI report multiplexing method during SD adaptation and/or PD adaptation for turning off a spatial element of the base station in a 5G mobile communication system may be provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of time-frequency resources as a wireless resource domain in a wireless communication system according to an embodiment;

FIG. 2 illustrates a slot structure considered in a wireless communication system according to an embodiment;

FIG. 3 illustrates an example of a time-domain mapping structure of a synchronization signal (SS) and a beam sweeping operation according to an embodiment;

FIG. 4 illustrates an SS block considered in a wireless communication system according to an embodiment;

FIG. 5 illustrates various transmission cases of an SS block in a frequency band of less than 6 GHz considered in a wireless communication system according to an embodiment;

FIG. 6 illustrates transmission cases of an SS block in a frequency band of 6 GHz or higher considered in a wireless communication system according to an embodiment;

FIG. 7 illustrates transmission cases of an SS block according to a subcarrier spacing within 5 ms in a wireless communication system according to an embodiment;

FIG. 8 illustrates a DMRS pattern (type 1 and type 2) used for communication between a base station and a terminal in a 5G system according to an embodiment;

FIG. 9 is illustrates an example of channel estimation using a DMRS received in one PUSCH in a time domain of a wireless communication system according to an embodiment;

FIG. 10 illustrates a method for reconfiguring SSB transmission through dynamic signaling of a wireless communication system according to an embodiment;

FIG. 11 illustrates a method for reconfiguring a BWP and a BW through dynamic signaling of a wireless communication system according to an embodiment;

FIG. 12 illustrates a method for reconfiguring discontinuous reception (DRX) through dynamic signaling of a wireless communication system according to an embodiment;

FIG. 13 illustrates a discontinuous transmission (DTx) method for energy saving of a base station according to an embodiment;

FIG. 14 illustrates an example of describing an operation of a base station according to a gNB wake-up signal according to an embodiment;

FIG. 15 illustrates an antenna adaptation method of a base station for energy saving of a wireless communication system according to an embodiment;

FIG. 16 illustrates a method for receiving terminal-specific CSI feedback for determining SD adaptation of a base station of a wireless communication system according to an embodiment;

FIG. 17 illustrates a CSI resource/resource set/report configuration method for determining terminal-specific SD adaptation of a base station of a wireless communication system according to an embodiment;

FIG. 18 illustrates an operation of transmitting multiple CSI reports by a base station and a terminal according to an embodiment;

FIG. 19 illustrates an operation of transmitting multiple CSI reports by a base station and a terminal for energy saving of the base station according to an embodiment;

FIG. 20 illustrates a method for multiplexing multiple CSI reports by a terminal according to an embodiment;

FIG. 21 illustrates a terminal to which an energy saving method of a wireless communication system is applied according to an embodiment;

FIG. 22 illustrates a base station to which an energy saving method of a wireless communication system is applied according to an embodiment;

FIG. 23 illustrates a terminal according to an embodiment; and

FIG. 24 illustrates a base station according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

In the accompanying drawings, some elements may be exaggerated, omitted, or schematically illustrated. Furthermore, the size of each element does not completely reflect the actual size. Identical or corresponding elements are provided with identical reference numerals.

Throughout the specification, the same or like reference signs indicate the same or like elements. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. LTE or LTE-A systems may be described herein by way of example, but the disclosure may also be applied to other communication systems having similar technical backgrounds or channel types. Examples of such communication systems may include 5G NR developed beyond LTE-A, and 5G covers the exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

As used herein, the unit refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more central processing units (CPUs) within a device or a security multimedia card. The unit may include one or more processors.

Method and devices disclosed herein may be applied without being limited to the respective embodiments, and one or more embodiments may be employed in combination. Therefore, based on determinations by those skilled in the art, the embodiments of the disclosure may be applied through some modifications without significantly departing from the scope of the disclosure.

The terms which will be described below are terms defined in consideration of the functions in the disclosure, and may be different according to users, intentions of the users, or customs. Therefore, the definitions of the terms should be made based on the contents throughout the specification.

A wireless communication system is advancing to a broadband wireless communication system for providing high-speed and high-quality packet data services using communication standards, such as high-speed packet access (HSPA) of 3GPP, LTE-Advanced (LTE-A), LTE-Pro, high-rate packet data (HRPD) of 3GPP2, ultra-mobile broadband (UMB), IEEE 802.17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (hereinafter UE) (or a mobile station (MS)) transmits data or control signals to a base station (BS or eNode B (eNB)), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC requires wider coverage than those of other services provided by the 5G communication system because the UEs are likely to be located in a shadow area, such as a basement of a building, which is not covered by the cell due to the nature of the service. The UE supporting mMTC must be configured to be inexpensive, and requires a very long battery life-time, such as 10 to 16 years, because it is difficult to frequently replace the battery of the UE.

Lastly, URLLC is a cellular-based mission-critical wireless communication service. For example, URLLC may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and must also assign a large number of resources in a frequency band in order to secure reliability of a communication link.

The three services in the 5G communication system (hereinafter may be interchangeably used with “5G system”), that is, eMBB, URLLC, and mMTC, may be multiplexed and transmitted in a single system. In order to satisfy different requirements of the respective services, different transmission/reception techniques and transmission/reception parameters may be used between the services.

Hereinafter, a frame structure of a 5G system is described in detail with reference to the drawings. A wireless communication system to which the disclosure is applied is described by using an example of a configuration of a 5G system for convenience of description, but the disclosure may be applied to 5G or other communication systems in the same or similar method.

Disclosed herein are methods for the following:
Configuring CSI reports and/or CSI resources (and/or CSI resource sets) having/including multiple antenna configuration hypotheses and power control offsets for spatial domain (SD) adaptation and/or power domain (PD) adaptation through higher-layer signaling;
Determining multiple CSI report configurations among multiple antenna configuration hypotheses, based on the configured information;
Determining priorities of multiple CSI reports according to multiple antenna configuration hypotheses, based on the configured information;
Determining a multiplexing method of multiple CSI reports on a PUSCH or a PUCCH, based on the determined priorities;
Applying SD and/or PD adaptation, based on the CSI report received from the terminal;
Configuring a CSI report and/or CSI resources (and/or CSI resource sets) having/including multiple antenna configuration hypotheses and power control offsets for SD and/or PD adaptation through higher-layer signaling;
Determining a configuration of a CSI report from among multiple antenna configuration hypotheses, based on the configured information;
Determining priorities of multiple CSI reports according to multiple antenna configuration hypotheses, based on the configured information;
Performing multiplexing of multiple CSI reports on a PUSCH or a PUCCH, based on the determined priorities; and
Transmitting the CSI report to the base station.

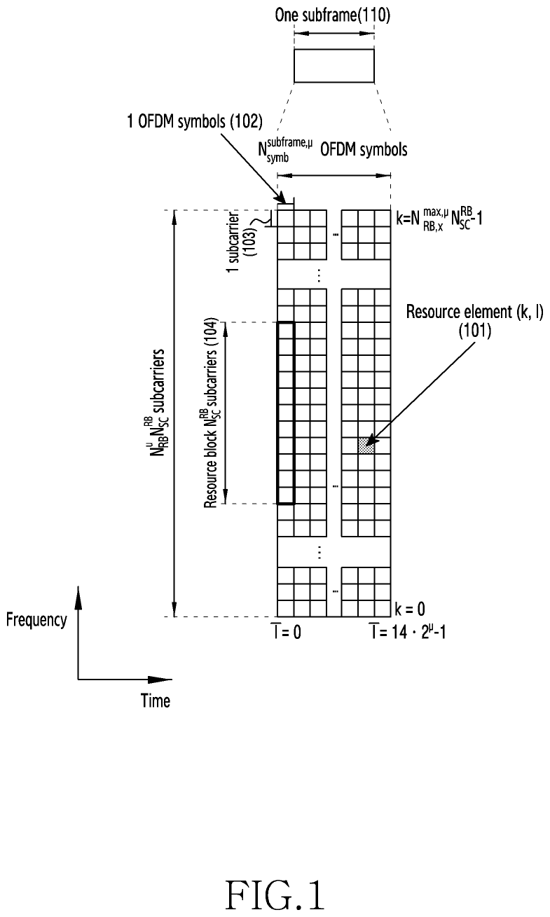

FIG. 1 illustrates a basic structure of time-frequency resources as a radio resource domain in a wireless communication system according to an embodiment.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. In the time domain, N_{symb}^{subframe,μ} (representing the number of symbols per subframe according to a configuration value u for the subcarrier spacing) consecutive OFDM symbols may constitute one subframe 110.

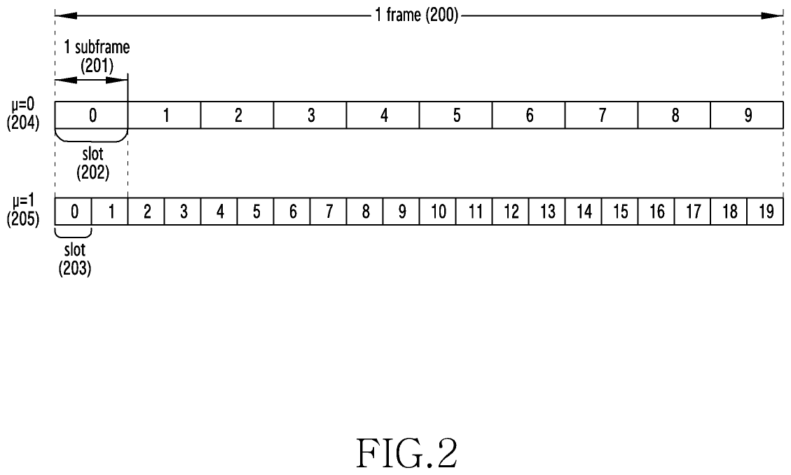

FIG. 2 illustrates a slot structure considered in a wireless communication system according to an embodiment.

Referring to FIG. 2, an example of a slot structure including a frame 200, a subframe 201, and a slot 202 is illustrated. One frame 200 may be defined as 10 milliseconds (ms). One subframe 201 may be defined as 1 ms, and thus one frame 200 may include a total of 10 subframes 201. One slot 202 or 203 may be defined as 14 OFDM symbols (that is, the number of symbols per one slot N_{symb}^{slot}=14). slot One subframe 201 may include one or multiple slots 202 and 203, and the number of slots 202 and 203 per one subframe 201 may differ depending on configuration values u 204 and 205 for the subcarrier spacing.

The subcarrier spacing configuration value in FIG. 2 is μ=0 (204), and μ=1 (205). In μ=0 (204), one subframe 201 may include one slot 202, and in μ=1 (205), one subframe 201 may include two slots 203. That is, the number of slots per one subframe Nₛₗₒₜ^{subframe,μ} may differ depending on the subcarrier spacing configuration value u, and the number of slots per one frame Nₛₗₒₜ^{frame,μ} slot may differ accordingly. For example, Nₛₗₒₜ^{subframe,μ} and Nₛₗₒₜ^{frame,μ} slot may be defined according to each subcarrier spacing configuration u as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In the 5G wireless communication system, an SS block (which may be interchangeably used with an SSB, or an SS/physical broadcast channel (SS/PBCH block) may be transmitted for initial access of the terminal, and the SS block may include a primary SS (PSS), a secondary SS (SSS), and a PBCH. In an initial access stage in which the terminal accesses a system, the terminal may obtain downlink time and frequency domain synchronization from a SS through a cell search and obtain a cell ID. The SS may include a PSS and an SSS. The terminal may receive, from the base station, a PBCH transmitting a master information block (MIB) to obtain system information related to transmission and reception, such as system bandwidth or related control information, and a basic parameter value. Based on the information, the terminal may perform decoding on a physical downlink control channel (PDCCH) and a physical downlink shared channel (PDSCH) to obtain a system information block (SIB). Thereafter, the terminal may exchange identification-related information of the base station and the terminal through a random access stage and initially access a network through registration and authentication stages. Additionally, the terminal may receive an SIB transmitted by the base station to obtain cell-common transmission/reception-related control information. The cell-common transmission/reception-related control information may include random access-related control information, paging-related control information, common control information relating to various physical channels, etc.

A SS is a reference signal for cell search, and a subcarrier spacing may be applied for each frequency band to suit a channel environment, such as phase noise. In a data channel or a control channel, different subcarrier spacings may be applied depending on service types to support various services as described above.

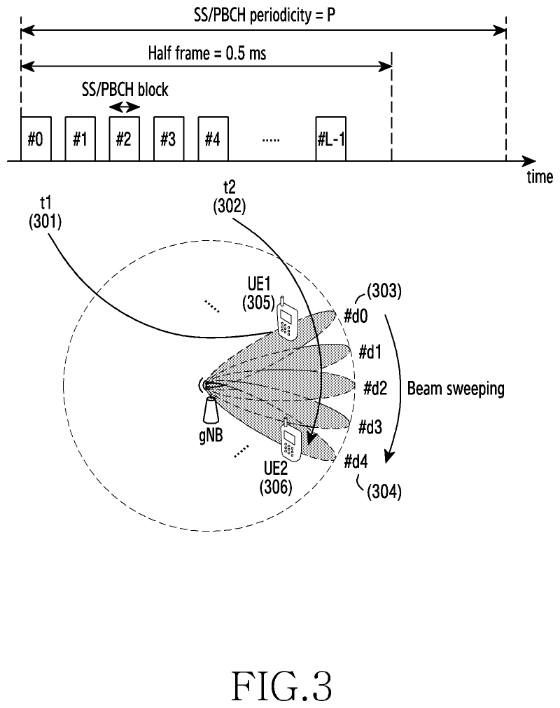

FIG. 3 illustrates an example of a time-domain mapping structure of a synchronization signal and a beam sweeping operation according to an embodiment.

For ease of description, the following components are defined.

Primary synchronization signal (PSS): A signal that is a reference signal for DL time/frequency synchronization and provides partial cell ID information.

Secondary synchronization signal (SSS): is a reference signal for DL time/frequency synchronization, and provides remaining partial cell ID information. Additionally, the SSS may serve as a reference signal for demodulation of a PBCH.

PBCH: provides a master information block (MIB), which is essential system information required for data channel and control channel transmission/reception by the terminal. The essential system information may include search space-related control information indicating radio resource mapping information of a control channel, scheduling control information for a separate data channel for transmitting system information, information such as a system frame number (SFN), which is the frame unit index serving as a timing reference, etc.

SS/PBCH block: The SS/PBCH block includes N OFDM symbols and is composed of a combination of the PSS, the SSS, the PBCH, etc. In a system to which beam sweeping technology is applied, the SS/PBCH block is a minimum unit to which beam sweeping is applied. In the 5G system, N=4. The base station may transmit up to L SS/PBCH blocks, and the L SS/PBCH blocks are mapped within a half frame (0.5 ms). The L SS/PBCH blocks are periodically repeated every predetermined period P. The base station may inform the terminal of period P through signaling. If there is no separate signaling for period P, the terminal applies a previously agreed upon default value.

Referring to FIG. 3, an example in which beam sweeping is applied in units of SS/PBCH blocks over time is illustrated. UE1 305 receives the SS/PBCH block by using a beam radiated in direction #d0 303 by beamforming applied to SS/PBCH block #0 at t1 301. UE2 306 receives the SS/PBCH block by using a beam radiated in direction #d4 304 by beamforming applied to SS/PBCH block #4 at t2 302. The terminal may obtain an optimal SS through the beam radiated from the base station in the direction where the terminal is positioned. For example, it may be difficult for UE1 305 to obtain time/frequency synchronization and essential system information from the SS/PBCH block through the beam radiated in direction #d4 away from the position of UE1.

In addition to the initial access procedure, the terminal may also receive the SS/PBCH block to determine whether a radio link quality of a current cell is maintained at a certain level or higher. In a handover procedure in which the terminal moves access from the current cell to a neighboring cell, the terminal may determine the radio link quality of the neighboring cell and receive the SS/PBCH block of the neighboring cell to obtain time/frequency synchronization of the neighboring cell.

The SS is a reference signal for cell search and may be transmitted while a subcarrier spacing appropriate for the channel environment (e.g., including phase noise) is applied for each frequency band. A 5G base station may transmit multiple SS blocks according to the number of analog beams to be operated. For example, a PSS and an SSS may be mapped over 12 RBs and transmitted, and a PBCH may be mapped over 24 RBs and transmitted.

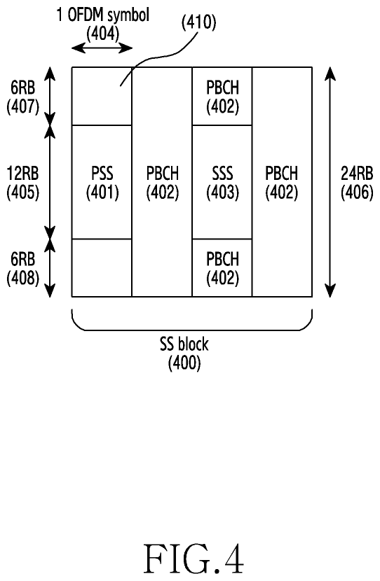

FIG. 4 illustrates a SS block considered in a wireless communication system according to an embodiment.

Referring to FIG. 4, an SS block may include a PSS 401, an SSS 403, and a PBCH 402.

The SS block 400 may be mapped to four OFDM symbols 404 on the time axis. The PSS 401 and the SSS 403 may be transmitted in 12 RBs 405 on the frequency axis, and in first and third OFDM symbols on the time axis, respectively. In the 5G system, for example, a total of 1008 different cell IDs may be defined. The PSS 401 may have three different values according to a physical cell ID (PCI) of a cell, and the SSS 403 may have 336 different values. The terminal may obtain one of (336×3=) 1008 cell IDs, as a combination, by detection on the PSS 401 and the SSS 403. This may be represented as in Equation (1) below.

$${N}_{ID}^{cell} = 3 {N}_{ID}^{( 1 )} + {N}_{ID}^{( 2 )} \qquad ( 1 )$$

In Equation (1), N_{ID}⁽¹⁾ may be estimated from the SSS 403, and have a value between 0 and 335. N_{ID}⁽²⁾ may be estimated from the PSS 401 and may have a value between 0 and 2. The terminal may estimate a value of N_{ID}^{(cell)} corresponding to a cell ID, by a combination of N_{ID}⁽¹⁾ and N_{ID}⁽²⁾.

The PBCH 402 may be transmitted in the resource including 24 RBs 406 on the frequency axis and 6 RBs 407 and 408 on both sides of each of the second and fourth OFDM symbols, except for the intermediate 12 RBs 405 where the SSS 403 is transmitted, on the time axis. The PBCH 402 may include a PBCH payload and a PBCH demodulation reference signal (DMRS). In the PBCH payload, various system information called MIB may be transmitted. For example, the MIB may include information as shown in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |
| } | |

SS block information: An offset in the frequency domain of the SS block may be indicated through 4-bit ssb-SubcarrierOffset in the MIB. The index of the SS block including the PBCH may be indirectly obtained through decoding of the PBCH DMRS and PBCH. In a frequency band below 6 GHZ, three bits obtained through decoding of the PBCH DMRS may indicate the SS block index and, in a frequency band above 6 GHz, a total of six bits including three bits obtained through decoding of the PBCH DMRS and three bits included in the PBCH payload and obtained by PBCH decoding may indicate the SS block index including the PBCH.

PDCCH configuration information: A subcarrier spacing of a common downlink control channel may be indicated through 1 bit (subCarrierSpacingCommon) in the MIB, and time-frequency resource configuration information of a search space (SS) and a control resource set (CORESET) may be indicated through eight bits (pdcch-ConfigSIB1).

System frame number (SFN): Six bits (systemFrameNumber) in the MIB may be used to indicate a part of the SFN. Four least significant bits (LSBs) of the SFN are included in the PBCH payload, and the terminal may indirectly obtain the same through PBCH decoding.

Timing information in the radio frame: This is one bit (half frame) obtained through PBCH decoding and included in the PBCH payload and the SS block index described above, and the terminal may indirectly identify whether the SS block is transmitted in the first or second half frame of the radio frame.

Since the transmission bandwidth (12 RBs 405) of the PSS 401 and the SSS 403 and the transmission bandwidth (24 RBs 406) of the PBCH 402 are different from each other, the first OFDM symbol where the PSS 401 is transmitted in the PBCH (402) transmission bandwidth has 6 RBs 407 and 408 on both sides except the intermediate 12 RBs where the PSS 401 is transmitted, and the area may be used to transmit other signals or may be empty.

The SS blocks may be transmitted using the same analog beam. For example, the PSS 401, the SSS 403, and the PBCH 402 may all be transmitted through the same beam. Since the analog beam cannot be applied differently on the frequency axis, the same analog beam may be applied to all the RBs on the frequency axis RBs within a specific OFDM symbol to which a specific analog beam is applied. All of the four OFDM symbols in which the PSS 401, the SSS 403, and the PBCH 402 are transmitted may be transmitted using the same analog beam.

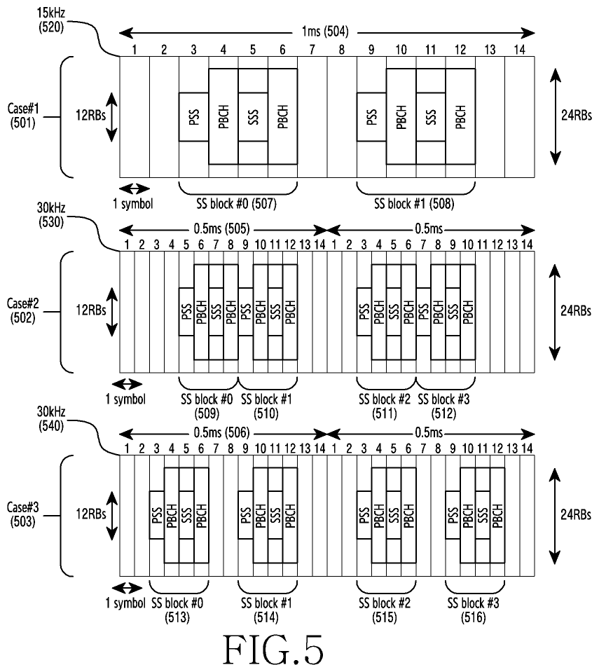

FIG. 5 illustrates various transmission cases of a SS block in a frequency band of less than 6 GHz considered in a wireless communication system according to an embodiment.

Referring to FIG. 5, in a frequency band (or frequency range 1 (FR1)) less than or equal to 6 GHz, a subcarrier spacing (SCS) 520 of 15 kHz and a SCS of 30 kHz 530 or 440 may be used for SS block transmission. In the 15 kHz SCS 520, there is one transmission case (e.g., case #1 501) for the SS block and, in the 30 kHz SCS 530 or 540, there may be two transmission cases for the SS block (e.g., case #2 502 and Case #3 503).

In FIG. 5, in case #1 501 of the 15 kHz SCS 520, up to two SS blocks may be transmitted within 1 ms 504 (or corresponding to a length of one slot when one slot includes 14 OFDM symbols). SS block #0 507 and SS block #1 508 are shown. For example, the SS block #0 507 may be mapped to four consecutive symbols from the third OFDM symbol, and the SS block #1 508 may be mapped to four consecutive symbols from the ninth OFDM symbol.

Different analog beams may be applied to the SS block #0 507 and the SS block #1 508. The same beam may be applied to all of the third to sixth OFDM symbols to which SS block #0 507 is mapped, and the same beam may be applied to all of the ninth to 12th OFDM symbols to which SS block #1 508 is mapped. In the seventh, eighth, 13th, and 14th OFDM symbols to which no SS block is mapped, an analog beam to be used may be freely determined under the determination of the base station.

In FIG. 5, in case #2 502 of the 30 kHz SCS 530, up to two SS blocks may be transmitted within 0.5 ms 505 (or corresponding to a length of one slot when one slot includes 14 OFDM symbols), and accordingly, up to four SS blocks may be transmitted within 1 ms (or corresponding to a length of two slots when one slot includes 14 OFDM symbols). FIG. 5 illustrates an example in which SS block #0 509, SS block #1 510, SS block #2 511, and SS block #3 512 are transmitted within 1 ms (i.e., two slots). SS block #0 509 and SS block #1 510 may be mapped from the fifth OFDM symbol and the ninth OFDM symbol, respectively, of the first slot. SS block #2 511 and SS block #3 512 may be mapped from the third OFDM symbol and the seventh OFDM symbol, respectively, of the second slot.

Different analog beams may be applied to SS block #0 509, SS block #1 510, SS block #2 511, and SS block #3 512. The same analog beam may be applied to the fifth to eighth OFDM symbols of the first slot in which SS block #0 509 is transmitted, the ninth to 12th OFDM symbols of the first slot in which SS block #1 510 is transmitted, the third to sixth symbols of the second slot in which SS block #2 511 is transmitted, and the seventh to 10th symbols of the second slot in which SS block #3 512 is transmitted. In the OFDM symbols to which no SS block is mapped, an analog beam to be used may be freely determined under the determination of the base station.

In FIG. 5, in case #3 503 of the 30 kHz SCS 540, up to two SS blocks may be transmitted within 0.5 ms 506 (or corresponding to a length of one slot when one slot includes 14 OFDM symbols), and accordingly, up to four SS blocks may be transmitted within 1 ms (or corresponding to a length of two slots when one slot includes 14 OFDM symbols). FIG. 4 illustrates an example in which SS block #0 513, SS block #1 514, SS block #2 515, and SS block #3 516 are transmitted within 1 ms (i.e., two slots). SS block #0 513 and SS block #1 514 may be mapped from the third OFDM symbol and the ninth OFDM symbol, respectively, of the first slot, and SS block #2 515 and SS block #3 516 may be mapped from the third OFDM symbol and the ninth OFDM symbol, respectively, of the second slot.

Different analog beams may be used for SS block #0 513, SS block #1 514, SS block #2 515, and SS block #3 516. As described above, the same analog beam may be used in all four OFDM symbols in which each SS block is transmitted, and a beam to be used in OFDM symbols to which no SS block is mapped may be freely determined by the base station.

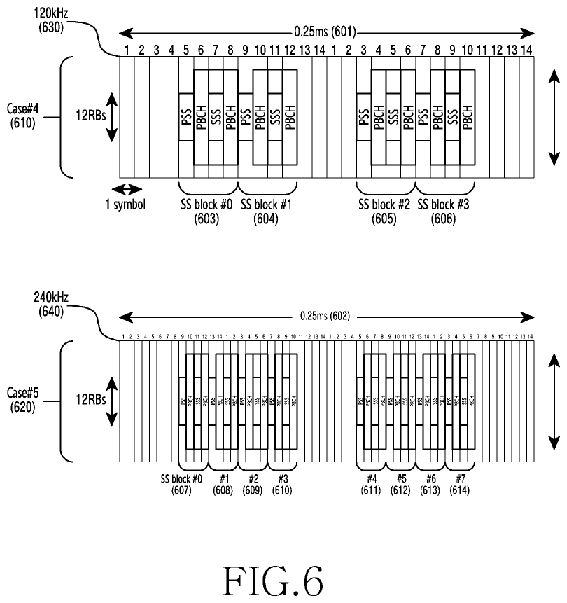

FIG. 6 illustrates transmission cases of an SS block in a frequency band of 6 GHz or higher (or FR2, e.g., 24250 MHz to 52600 MHZ) considered in a wireless communication system according to an embodiment.

Referring to FIG. 6, in the wireless communication system, in a frequency band of 6 GHz or higher, the sub-carrier spacing of 120 kHz 630 as in the example of case #4 610 and the sub-carrier spacing of 240 kHz 640 as in the example of case #5 620 may be used for SS block transmission.

In case #4 610 of the 120 kHz SCS 630, up to four SS blocks may be transmitted within 0.25 ms 601 (or corresponding to a length of two slots when one slot includes 14 OFDM symbols). FIG. 6 illustrates an example in which SS block #0 603, SS block #1 604, SS block #2 605, and SS block #3 606 are transmitted within 0.25 ms 601 (i.e., two slots). SS block #0 603 and SS block #1 604 may be mapped to four consecutive symbols from the fifth OFDM symbol and to four consecutive symbols from the ninth OFDM symbol, respectively, of the first slot, and SS block #2 605 and SS block #3 606 may be mapped to four consecutive symbols from the third OFDM symbol and to four consecutive symbols from the seventh OFDM symbol, respectively, of the second slot.

As described above, different analog beams may be used for SS block #0 603, SS block #1 604, SS block #2 605, and SS block #3 606. The same analog beam may be used in all four OFDM symbols in which each SS block is transmitted, and a beam to be used in OFDM symbols to which no SS block is mapped may be freely determined by the base station.

In case #5 620 of the 240 kHz SCS 640, up to eight SS blocks may be transmitted within 0.25 ms 602 (or corresponding to a length of four slots when one slot includes 14 OFDM symbols). In FIG. 6, SS block #0 607, SS block #1 608, SS block #2 609, SS block #3 610, SS block #4 611, SS block #5 612, SS block #6 613, and SS block #7 614 are transmitted within 0.25 ms 602 (i.e., 4 slots).

SS block #0 607 and SS block #1 608 may be mapped to four consecutive symbols from the 9th OFDM symbol and to four consecutive symbols from the 13th OFDM symbol, respectively, of the first slot, SS block #2 609 and SS block #3 610 may be mapped to four consecutive symbols from the third OFDM symbol and to four consecutive symbols from the seventh OFDM symbol, respectively, of the second slot, SS block #4 611, SS block #5 612, and SS block #6 613 may be mapped to four consecutive symbols from the fifth OFDM symbol, to four consecutive symbols from the ninth OFDM symbols, and to four consecutive symbols from the 13th OFDM symbol, respectively, of the third slot, and SS block #7 614 may be mapped to four consecutive symbols from the third OFDM symbol of the fourth slot.

As described above, SS block #0 607, SS block #1 608, SS block #2 609, SS block #3 610, SS block #4 611, SS block #5 612, SS block #6 613, and SS block #7 614 may use different analog beams. The same analog beam may be used in all four OFDM symbols in which each SS block is transmitted, and a beam to be used in OFDM symbols to which no SS block is mapped may be freely determined by the base station.

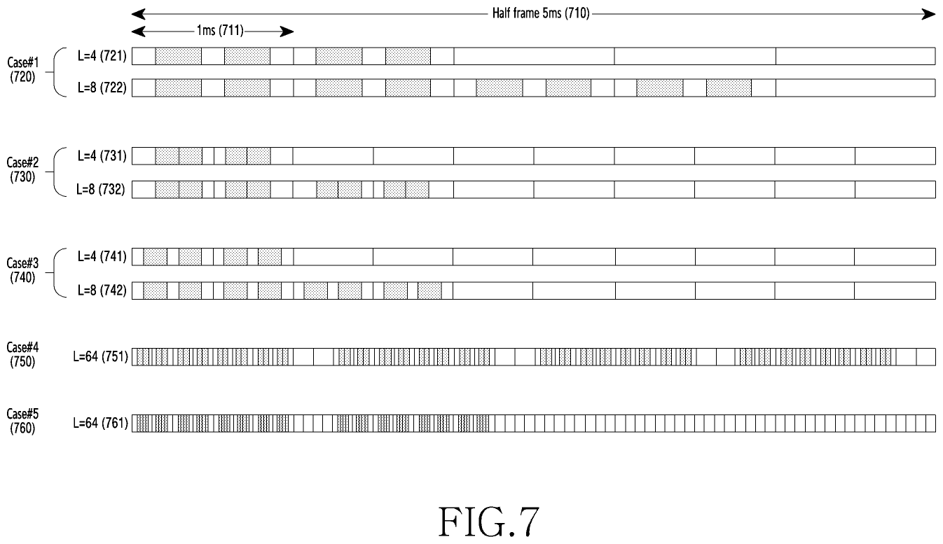

FIG. 7 illustrates transmission cases of an SS block according to a SCS within 5 ms in a wireless communication system according to an embodiment.

Referring to FIG. 7, in the 5G communication system, SS blocks may be transmitted periodically, e.g., every time interval 710 of 5 ms (corresponding to five subframes or a half frame).

In a frequency band of 3 GHz or less, up to four SS blocks may be transmitted within 5 ms 710. Up to eight SS blocks may be transmitted in a frequency band above 3 GHZ and below 6 GHz. In a frequency band above 6 GHz, up to 64 SS blocks may be transmitted. The SCSs of 15 kHz and 30 kHz may be used at frequencies less than or equal to 6 GHz.

In FIG. 7, in case #1 501 of the 15 kHz SCS including one slot of FIG. 5, in a frequency band of 3 GHz or less, SS blocks may be mapped to the first slot and the second slot so that up to four SS blocks 721 may be transmitted, and in a frequency band above 3 GHz and below 6 GHz, SS blocks may be mapped to the first, second, third, and fourth slots, so that up to eight SS blocks 722 may be transmitted. In case #2 502 or case #3 503 of the 30 kHz SCS including two slots in FIG. 5, in a frequency band below 3 GHZ, SS blocks may be mapped starting from the first slot, so that up to four SS blocks 731 and 741 may be transmitted, and in a frequency band above 3 GHz and below 6 GHz, SS blocks may be mapped starting from the first and third slots, so that up to eight SS blocks 732 and 742 may be transmitted.

The SCSs of 120 kHz and 240 kHz may be used at frequencies above 6 GHz. In FIG. 7, in case #4 610 of the 120 kHz SCS consisting of two slots of FIG. 6, in a frequency band above 6 GHz, SS blocks may be mapped starting from 1^{st}, 3^{rd}, 5^{th}, 7^{th}, 11^{th}, 13^{th}, 15^{th}, 17^{th}, 21^{st}, 23^{rd}, 25^{th}, 27^{th}, 31^{st}, 33^{rd}, 35^{th}, and 37^{th} slots so that up to 64 SS blocks 751 may be transmitted. In FIG. 7, in case #5 620 of the 240 kHz SCS consisting of 4 slots of FIG. 6, in a frequency band above 6 GHZ, SS blocks may be mapped starting from the 1^{st}, 5^{th}, 9^{th}, 13^{th}, 21^{st}, 25^{th}, 29^{th}, and 33^{rd} slots so that up to 64 SS blocks 761 may be transmitted.

The terminal may obtain the SIB after decoding the PDCCH and the PDSCH based on the system information included in the received MIB. The SIB may include at least one of uplink cell bandwidth-related information, a random access parameter, a paging parameter, or a parameter related to uplink power control.

The terminal may form a radio link with the network through a random access procedure based on the system information and synchronization with the network obtained in the cell search process of the cell. For random access, a contention-based or contention-free scheme may be used. When the terminal performs cell selection and reselection in the stage of initial access to the cell, a contention-based random access scheme may be used for the purpose of switching from the RRC_IDLE (RRC idle) state to the RRC_CONNECTED (RRC connected) state. The contention-free random access may be used when downlink data arrives, in handover, or for re-establishing uplink synchronization for location measurement. Table 3 below illustrates conditions (events) under which a random access procedure is triggered in the 5G system.

```
TABLE 3
  - Initial access from RRC_IDLE;
  - RRC Connection Re-establishment procedure;
  - DL or UL data arrival during RRC_CONNECTED when UL
synchronization status is “non-synchronized”;
  - UL data arrival during RRC_CONNECTED when there are no
PUCCH resources for SR available;
  - SR failure;
  - Request by RRC upon synchronous reconfiguration (e.g. handover);
  - RRC Connection Resume procedure from RRC_INACTIVE;
  - To establish time alignment for a secondary TAG;
  - Request for Other SI;
  - Beam failure recovery;
  - Consistent UL LBT failure on SpCell.
```

The terminal receives MeasObjectNR of MeasObjectToAddModlist as configurations for SSB-based intra/inter-frequency measurements and CSI-RS-based intra/inter-frequency measurements through higher-layer signaling. For example, MeasObjectNR may be configured as shown in Table 4 below.

TABLE 4

| | |
|---|---|
| MeasObjectNR ::= | SEQUENCE { |

| | |
|---|---|
| ssbFrequency ARFCN-ValueNR | OPTIONAL, |

-- Cond SSBorAssociatedSSB

| | |
|---|---|
| ssbSubcarrierSpacing | SubcarrierSpacing |

OPTIONAL, -- Cond SSBorAssociatedSSB

| | | |
|---|---|---|
| smtc1 | SSB-MTC | OPTIONAL, |

-- Cond SSBorAssociatedSSB

| | | |
|---|---|---|
| smtc2 | SSB-MTC2 | OPTIONAL, |

-- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS- |

| | |
|---|---|
| BlocksToAverage) | OPTIONAL, -- Need R |

| | |
|---|---|
| nrofCSI-RS-ResourcesToAverage | INTEGER (2..maxNrofCSI-RS- |

| | |
|---|---|
| ResourcesToAverage) | OPTIONAL, -- Need R |
| quantityConfigIndex | INTEGER (1..maxNrofQuantityConfig), |
| offsetMO | Q-OffsetRangeList, |

| | |
|---|---|
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList | SEQUENCE (SIZE (1..maxNrofPCI- |

Ranges)) OF PCI-RangeElement OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI- |

```
Ranges)) OF PCI-RangeElement OPTIONAL, -- Need N
    ...,
    [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, |

```
sf640, sf1024, sf1280} OPTIONAL -- Need R
    ]],
    [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
    ]]
  }
```

The terms used in Table 4 may perform the following functions. However, the functions are not limited thereto.

ssbFrequency: may configure the frequency of the SS related to MeasObjectNR.

ssbSubcarrierSpacing: configures the SCS of SSB. FR1 may only apply 15 kHz or 30 kHz, and FR2 may only apply 120 kHz or 240 kHz.

smtc1: indicates the SS/PBCH block measurement timing configuration, and may configure the primary measurement timing configuration and configure the timing offset and duration for SSB.

smtc2: may configure the secondary measurement timing configuration for SSB related to MeasObjectNR with the PCI listed in the pci-List.

The SMTC may also be configured through other higher-layer signaling. For example, the SMTC may be configured in the terminal through reconfigurationWithSync for NR PSCell change or NR PCell change or SIB2 for intra-frequency, inter-frequency, and inter-RAT cell reselection, and in addition, the SMTC may be configured in the terminal through SCellConfig for adding an NR SCell.

The terminal may configure the first SS/PBCH block measurement timing configuration (SMTC) according to the periodicityAndOffset (providing periodicity and offset) through smtc1 configured through higher-layer signaling for SSB measurement. The first subframe of each SMTC occasion may start in the subframe of SpCell and the system frame number (SFN) satisfying the conditions of Table 5 below.

TABLE 5

SFN mod T = (FLOOR (Offset/10));
if the Periodicity is larger than sf5:
subframe = Offset mod 10;
else:
subframe = Offset or (Offset +5);
with T = CEIL(Periodicity/10).

If smtc2 is configured, the terminal may configure an additional SMTC according to the configured offset and duration of smtc1 and the periodicity of smtc2, for the cells indicated by the pci-List value of smtc2 in the same MeasObjectNR. The terminal may receive the configuration of the smtc and measure the SSB through the smtc3 list for smtc2-LP (with long periodicity) and IAB mobile termination (IAB-MT) for the same frequency (e.g., frequency for intra frequency cell reselection) or other frequencies (e.g., frequencies for inter frequency cell reselection). The terminal may not consider the SSB transmitted in a subframe other than the SMTC occasion for SSB-based RRM measurement at the configured ssbFrequency. The base station may use various multi-transmit/receive point (TRP) operation methods depending on the serving cell configuration and physical cell identifier (PCI) configuration. There may be two methods for operating the two TRPs when two TRPs positioned in a distance physically away from each other have different PCIs.

### Method 1

The two TRPs having different PCIs may be operated as two serving cell configurations.

The base station may include the channels and signals transmitted in different TRPs through method 1 in different serving cell configurations and configure the same. In other words, each TRP may have an independent serving cell, and frequency bandwidth value FrequencyInfoDLs indicated by the DownlinkConfigCommon in the serving cell configurations may indicate bands that at least partially overlap each other. Since the several TRPs operate based on multiple ServCellIndexes (e.g., ServCellIndex #1 and ServCellIndex #2), each TRP may use a separate PCI. That is, the base station may assign one PCI to each ServCellIndex.

In this case, when several SSBs are transmitted in TRP 1 and TRP 2, the SSBs may have different PCIs (e.g., PCI #1 and PCI #2), and the base station may properly select the ServCellIndex value indicated by the cell parameter in QCL-Info, map the PCI suitable for each TRP, and designate the SSB transmitted in either TRP 1 or TRP 2 as the source reference RS of the QCL configuration information. However, this configuration applies one serving cell configuration available for carrier aggregation (CA) to multiple TRPs and may thus restrict the degree of freedom of the CA configuration or increase signaling loads.

### Method 2

The two TRPs having different PCIs may be operated as one serving cell configuration.

The base station may configure the channels and signals transmitted in different TRPs through method 2 through one serving cell configuration. Since the terminal operates based on one ServCellindex (e.g., ServCellindex #1), it is impossible to recognize the PCI assigned to the second TRP (e.g., PCI #2). Method 2 may have a degree of freedom of CA configuration as compared to method 1 described above. However, when several SSBs are transmitted in TRP 1 and TRP 2, the SSBs may have different PCIs (e.g., PCI #1 and PCI #2), and the base station may not be able to map the PCI (e.g., PCI #2) of the second TRP through the ServCellIndex indicated by the cell parameter in QCL-Info. The base station may only designate the SSB transmitted in TRP 1 with the source reference RS of the QCL configuration information and may not be able to designate the SSB transmitted in TRP 2.

As described above, method 1 may perform multi-TRP operation for two TRPs having different PCIs through an additional serving cell configuration without support of additional specifications, but method 2 may operate based on the following additional UE capability report and base station configuration information.

### Terminal Capability Report for Method 2

The terminal may report, to the base station, through terminal capability, that it is possible to configure the PCI of the serving cell and another additional PCI through higher-layer signaling from the base station. The terminal capability may include X1 and X2 which are numbers independent of each other, or X1 and X2 may be reported as independent UE capabilities.

X1 indicates the maximum number of additional PCIs configurable for the terminal. The PCI may be different from the PCI of the serving cell and, in this case, may mean a case where the time domain position and periodicity of the SSB corresponding to the additional PCI are the same as those of the SSB of the serving cell.

X2 indicates the maximum number of additional PCIs configurable for the UE. In this case, the PCI may be different from the PCI of the serving cell and, in this case, may mean a case where the time domain position and periodicity of the SSB corresponding to the additional PCI are different from those of the SSB corresponding to the PCI reported as X1.

By definition, the PCIs corresponding to the values reported as X1 and X2 may not be configured simultaneously with each other.

The values reported as X1 and X2 reported through the terminal capability report may each have a value of one integer from 0 to 7.

The values reported as X1 and X2 may be reported as different values in FR1 and FR2.

### Higher-Layer Signaling Configuration for Method 2

The terminal may receive, based on the above-described terminal capability report, a configuration of SSB-MTCAdditionalPCI-r17, which is higher-layer signaling, from the base station, and the higher-layer signaling may include multiple additional PCIs having different values from at least the serving cell, the SSB transmission power corresponding to each additional PCI, and ssb-PositionInBurst corresponding to each additional PCI. The maximum number of additional PCIs configurable may be seven.

The terminal may be assumed to have the same center frequency, SCS, and subframe number offset as those of the serving cell as an assumption for the SSB configured to an additional PCI having a different value from that of the serving cell.

The terminal may assume that the reference RS (e.g., SSB or CSI-RS) corresponding to the PCI of the serving cell is connected to the always-active TCI state. When there are one or more additionally configured PCIs having a value different from the serving cell, only one PCI among the PCIs may be assumed to be connected to the activated TCI state.

When the terminal receives configuration of two different coresetPoolIndexes, the reference RS corresponding to the serving cell PCI is connected to one or more activated TCI states, and the reference RS corresponding to the additionally configured PCI having a different value from that of the serving cell is connected to one or more activated TCI states, the terminal may expect that the activated TCI state(s) connected with the serving cell PCI are connected to one of the two coresetPoolIndexes, and the activated TCI state(s) connected with the additionally configured PCI having a different value from that of the serving cell are connected to the remaining one coresetPoolIndex.

Terminal capability reporting and base station higher-layer signaling for method 2 described above may configure an additional PCI having a value different from that of the PCI of the serving cell. When the configuration is absent, the SSB corresponding to the additional PCI having a different value from the PCI of the serving cell which may not be designated by the source reference RS may be used for the purpose of designating the source reference RS of the QCL configuration information. Unlike the SSB configurable used for RRM, mobility, or handover, such as the configuration information about the SSB configurable in smtc1 and smtc2 which is the higher-layer signaling, it may be used to serve as a QCL source RS for supporting multi-TRP operations having different PCIs.

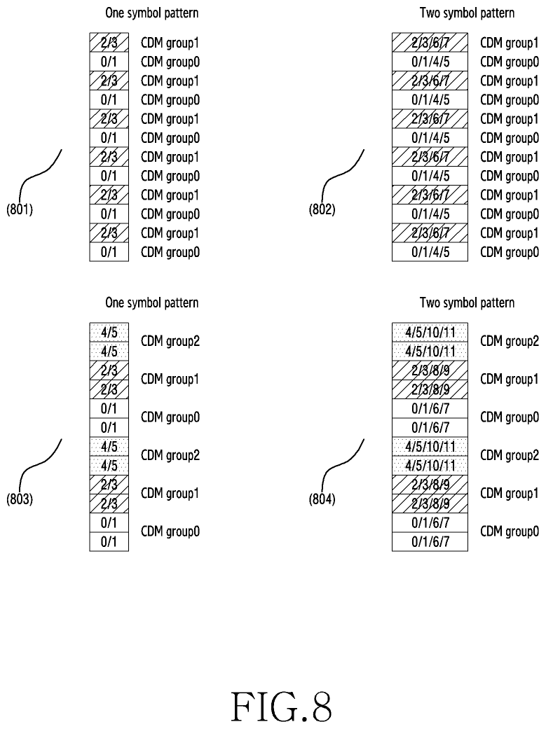

A demodulation reference signal (DMRS) may include several DMRS ports, and the respective ports maintain orthogonality to avoid interference with each other by using code division multiplexing (CDM) or frequency division multiplexing (FDM). However, DMRS may be replaced with another term depending on the user's intent or the purpose of use of the reference signal. FIG. 8 illustrates a DMRS pattern (type 1 and type 2) used for communication between a base station and a terminal in a wireless communication system according to an embodiment.

In the 5G system, two DMRS patterns may be supported. FIG. 8 illustrates two DMRS patterns.

Referring to FIG. 8, DMRS type 1 801 and 802 are illustrated. Specifically, 1-symbol pattern 801 and 2-symbol pattern 802 are illustrated. DMRS type 1 801 or 802 is a comb 2-structure DMRS pattern and may include two CDM groups. The different CDM groups may be FDMed.

In the 1-symbol pattern 801, frequency CDM is applied to the same CDM group, which allows the two DMRS ports to be distinguished from each other. Therefore, a total of 4 orthogonal DMRS ports may be configured. The 1-symbol pattern 801 may include a DMRS port ID mapped to each CDM group (DMRS port ID for downlink may be represented by “shown number+1000”). In the 2-symbol pattern 802, time/frequency CDM is applied to the same CDM group, which allows the four DMRS ports to be distinguished from one another. Therefore, a total of 8 orthogonal DMRS ports may be configured. The 2-symbol pattern 802 may include a DMRS port ID mapped to each CDM group (DMRS port ID for downlink may be represented by “shown number+1000).

FIG. 8 illustrates DMRS type 2 803 or 804, which is a DMRS pattern having a structure in which frequency domain orthogonal cover codes (FD-OCC) are applied to subcarriers adjacent in frequency and may include three CDM groups. The different CDM groups may be FDMed.

In the 1-symbol pattern 803, frequency CDM is applied to the same CDM group, which allows the two DMRS ports to be distinguished from each other, and therefore, a total of 6 orthogonal DMRS ports may be configured. The 1-symbol pattern 803 may include a DMRS port ID mapped to each CDM group (DMRS port ID for downlink may be represented by “shown number+1000”). In the 2-symbol pattern 804, time/frequency CDM is applied to the same CDM group, which allows the four DMRS ports to be distinguished from one another, and therefore, a total of 12 orthogonal DMRS ports may be configured. The 2-symbol pattern 804 may include a DMRS port ID mapped to each CDM group (DMRS port ID for downlink may be represented by “shown number+1000”).

As described above, in the NR system, two different DMRS patterns (e.g., DMRS type 1 801 and 802 or DMRS type 2 803 or 804) may be configured, and whether each DMRS pattern is a one symbol pattern 801 or 803 or an adjacent-two-symbol pattern 802 or 804 may also be configured. In addition, in the NR system, not only DMRS port numbers are scheduled, but also the number of CDM groups scheduled together may be set and signaled for PDSCH rate matching. Furthermore, in cyclic prefix based orthogonal frequency division multiplex (CP-OFDM), both the DMRS patterns described above may be supported in DL and UL, and in discrete Fourier transform spread OFDM (DFT-S-OFDM), only DMRS type1 801 or 802 among the DMRS patterns described above may be supported in UL.

In addition, the NR system may be supported to configure additional DMRSs. A front-loaded DMRS refers to the first DMRS transmitted/received in the first symbol in the time domain among DMRSs, and an additional DMRS refers to a DMRS transmitted/received in a symbol behind the front-loaded DMRS in the time domain. In the NR system, the number of additional DMRSs may be configured from a minimum of 0 to a maximum of 3. When an additional DMRS is configured, the same pattern as the front-loaded DMRS may be assumed. When information on whether the DMRS pattern type described above for the front-loaded DMRS is type 1 or type 2, information on whether the DMRS pattern is a one-symbol pattern or an adjacent-two-symbol pattern, and information on the number of DMRS ports and used CDM groups are indicated, when an additional DMRS is further configured, it may be assumed that the same DMRS information as the front-loaded DMRS is configured for the additional DMRS.

The downlink DMRS configuration described above may be configured through RRC signaling as shown in Table 6 below.

TABLE 6

| DMRS-DownlinkConfig ::= | | SEQUENCE { |
|---|---|---|
| dmrs-Type | ENUMERATED {type2} | OPTIONAL, -- Need S |

dmrs-AdditionalPosition ENUMERATED {pos0, pos1, pos3} OPTIONAL,
-- Need S

| | | |
|---|---|---|
| maxLength | ENUMERATED {len2} | OPTIONAL, -- Need S |
| scramblingID0 | INTEGER (0..65535) | OPTIONAL, -- Need S |
| scramblingID1 | INTEGER (0..65535) | OPTIONAL, -- Need S |

| | |
|---|---|
| phaseTrackingRS | SetupRelease {PTRS-DownlinkConfig} OPTIONAL, |

```
-- Need M
      ...
  }
```

In Table 6, dmrs-type may configure the DMRS type, dmrs-AdditionalPosition may configure additional DMRS OFDM symbols, maxLength may configure 1-symbol DMRS pattern or 2-symbol DMRS pattern, scramblingID0 and scramblingID1 may configure scrambling IDs, and phaseTrackingRS may configure a phase tracking reference signal (PTRS). The uplink DMRS configuration described above may be configured through RRC signaling as shown in Table 7 below.

TABLE 7

| | |
|---|---|
| DMRS-UplinkConfig ::= | SEQUENCE { |

| | | |
|---|---|---|
| dmrs-Type | ENUMERATED {type2} | OPTIONAL, -- Need |

S

| | |
|---|---|
| dmrs-AdditionalPosition | ENUMERATED {pos0, pos1, pos3} |

OPTIONAL, -- Need R

| | |
|---|---|
| phaseTrackingRS | SetupRelease { PTRS-UplinkConfig } |

OPTIONAL, -- Need M

| | | |
|---|---|---|
| maxLength | ENUMERATED {len2} | OPTIONAL, -- |

Need S
transformPrecodingDisabled SEQUENCE {

| | | |
|---|---|---|
| scramblingID0 | INTEGER (0..65535) | OPTIONAL, -- |

Need S

| | | |
|---|---|---|
| scramblingID1 | INTEGER (0..65535) | OPTIONAL, -- |

Need S
...

| | |
|---|---|
| } | OPTIONAL, -- Need R |

transformPrecodingEnabled SEQUENCE {

| | | |
|---|---|---|
| nPUSCH-Identity | INTEGER (0..1007) | OPTIONAL, -- |

Need S

| | | |
|---|---|---|
| sequenceGroupHopping | ENUMERATED | {disabled} |

OPTIONAL, -- Need S

| | | |
|---|---|---|
| sequenceHopping | ENUMERATED {enabled} | OPTIONAL, |

-- Need S
...

| | |
|---|---|
| } | OPTIONAL, -- Need R |

```
    ...
  }
```

The dmrs-Type may configure the DMRS type, dmrs-AdditionalPosition may configure additional DMRS OFDM symbols, phaseTrackingRS may configure PTRS, and maxLength may configure 1-symbol DMRS pattern or 2-symbol DMRS pattern. Furthermore, scramblingID0 and scramblingID1 may configure scrambling ID0s, nPUSCH-Identity may configure the cell ID for DFT-s-OFDM, sequenceGroupHopping may disable sequence group hopping, and sequenceHopping may enable sequence hopping.

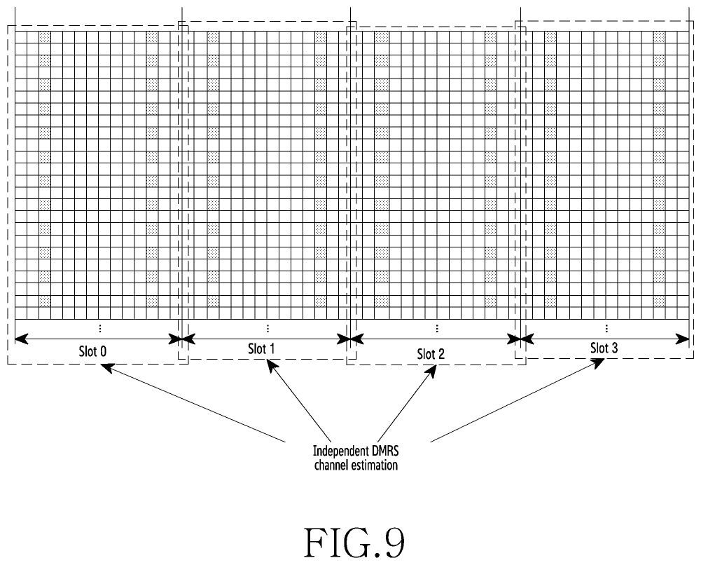

FIG. 9 illustrates an example of channel estimation using a DMRS received in one PUSCH in a time domain of a wireless communication system according to an embodiment.

Referring to FIG. 9, in performing DMRS channel estimation for data decoding by a DMRS, channel estimation may be performed within a precoding resource block group (PRG), which is a corresponding bundling unit, by using physical resource block (PRB) bundling linked to a system band in the frequency band. In a unit of time, channel estimation is performed under the assumption that precoding is the same for the DMRS received on only one PUSCH.

The following describes a method for time domain resource allocation (TDRA) for a data channel in a 5G communication system. The base station may configure, for the terminal, a table for time domain resource allocation information for a physical downlink shared channel (PDSCH) and a physical uplink shared channel (PUSCH) via higher-layer signaling (e.g., RRC signaling).

For a PDSCH, the base station may configure a table including up to maxNrofDL-Allocations=17 entries and, for PUSCH, configure a table including up to maxNrofUL-Allocations=17 entries. The time domain resource allocation information may include at least one of, e.g., PDCCH-to-PDSCH slot timing (which corresponds to a time interval between the time of reception of the PDCCH and the time of transmission of the PDSCH scheduled by the received PDCCH, and is indicated as K0) or PDCCH-to-PUSCH slot timing (which corresponds to a time interval between the time of PDCCH and the time of transmission of the PUSCH scheduled by the received PDCCH, and is indicated as K2), information for the position and length of a start symbol where the PDSCH or PUSCH is scheduled in the slot, and a mapping type of PDSCH or PUSCH.

Time domain resource allocation information for the PDSCH may be configured for the terminal through RRC signaling as shown in Table 8 below.

TABLE 8
PDSCH-TimeDomainResourceAllocationList information element

| | | |
|---|---|---|
| PDSCH-TimeDomainResourceAllocationList | ::= | SEQUENCE |

(SIZE(1..maxNrofDL-Allocations)) OF PDSCH-TimeDomainResourceAllocation

| PDSCH-TimeDomainResourceAllocation ::= | | SEQUENCE { |
|---|---|---|
| k0 | INTEGER(0..32) | OPTIONAL, -- Need S |

| | |
|---|---|
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} |

OPTIONAL, -- Cond Formats1-0and(2)
}

k0 may indicate the PDCCH-to-PDSCH timing (i.e., the slot offset between the downlink control information (DCI) and the scheduled PDSCH) in each unit of slot, mappingType may indicate the PDSCH mapping type, startSymbolAndLength may indicate the start symbol and length of the PDSCH, and repetitionNumber may indicate the number of PDSCH transmission occasions according to the slot-based repetition scheme. Time domain resource allocation information for the PUSCH may be configured to the terminal through RRC signaling as shown in Table 9 below.

TABLE 9
PUSCH-TimeDomainResourceAllocation information element

```
  PUSCH-TimeDomainResourceAllocationList ::= SEQUENCE
(SIZE(1..maxNrofUL-Allocations)) OF PUSCH-TimeDomainResourceAllocation
  PUSCH-TimeDomainResourceAllocation ::= SEQUENCE {
```

| | |
|---|---|
| k2 | INTEGER(0..32) OPTIONAL, -- Need S |
| mappingType | ENUMERATED {typeA, typeB}, |
| startSymbolAndLength | INTEGER (0..127) |

```
  }
  PUSCH-Allocation-r16 ::= SEQUENCE {
```

| | |
|---|---|
| mappingType-r16 | ENUMERATED {typeA, typeB} OPTIONAL, - |

- Cond NotFormat01-02-Or-TypeA
startSymbolAndLength-r16 INTEGER (0..127) OPTIONAL, -- Cond
NotFormat01-02-Or-TypeA

| | |
|---|---|
| startSymbol-r16 | INTEGER (0..13) OPTIONAL, -- Cond RepTypeB |
| length-r16 | INTEGER (1..14) OPTIONAL, -- Cond RepTypeB |

```
    numberOfRepetitions-r16 ENUMERATED {n1, n2, n3, n4, n7, n8, n12,
n16} OPTIONAL, -- Cond Format01-02
    ...
  }
```

In Table 9, k2 may indicate the PDCCH-to-PUSCH timing (i.e., the slot offset between the DCI and the scheduled PUSCH) in each unit of slot, mapping Type may indicate the PUSCH mapping type, startSymbolAndLength or StartSymbol and length may indicate the start symbol and length of the PUSCH, and numberOfRepetitions may indicate the number of repetitions applied to PUSCH transmission. The base station may indicate, for the terminal, at least one of the entries in the table for the time domain resource allocation information through layer 1 (L1) signaling (e.g., DCI) (which may be indicated with, e.g., the “time domain resource allocation” field in the DCI). The terminal may obtain, based on the DCI received from the base station, time domain resource allocation information for the PDSCH or PUSCH.

Transmission of a physical uplink shared channel (PUSCH) in the 5G system is described below. PUSCH transmission may be dynamically scheduled by a UL grant in the DCI (e.g., referred to as dynamic grant (DG)-PUSCH), or may be scheduled by configured grant type 1 or configured grant type 2 (e.g., referred to as configured grant (CG)-PUSCH). Dynamic scheduling for PUSCH transmission may be indicated through, e.g., DCI format 0_0 or 0_1.

PUSCH transmission of configured grant type 1 may be semi-statically configured through reception of configuredGrantConfig including rrc-ConfiguredUplinkGrant of Table 10 below through higher-layer signaling without reception of the UL grant in the DCI. PUSCH transmission of configured grant type 2 may be semi-persistently scheduled by the UL grant in the DCI after receiving the configuredGrantConfig that does not include rrc-ConfiguredUplinkGrant of Table 10 below through higher-layer signaling.

When PUSCH transmission is scheduled by the configured grant, parameters applied to PUSCH transmission may be configured through configuredGrantConfig which is the higher-layer signaling of Table 10> below, except for specific parameters (e.g., dataScramblingIdentityPUSCH, txConfig, codebookSubset, maxRank, or scaling of UCI-OnPUSCH) provided through pusch-Config of Table 11 below which is higher-layer signaling. For example, if the terminal receives transformPrecoder through configuredGrantConfig, which is higher-layer signaling of Table 10 below, the terminal may apply tp-pi2BPSK in push-Config of Table 11 below for PUSCH transmission operated by the configured grant.

TABLE 10
ConfiguredGrantConfig

ConfiguredGrantConfig ::= SEQUENCE {

| | |
|---|---|
| frequencyHopping | ENUMERATED {intraSlot, interSlot} |

OPTIONAL, -- Need S,
cg-DMRS-Configuration DMRS-UplinkConfig,

| | |
|---|---|
| mcs-Table | ENUMERATED {qam256, qam64LowSE} |

OPTIONAL, -- Need S
mcs-TableTransformPrecoder ENUMERATED {qam256, qam64LowSE}
OPTIONAL, -- Need S

| | |
|---|---|
| uci-OnPUSCH | SetupRelease { CG-UCI-OnPUSCH } OPTIONAL, |

-- Need M

| | |
|---|---|
| resourceAllocation | ENUMERATED { resourceAllocationType0, |

resourceAllocationType1, dynamicSwitch },

| | | |
|---|---|---|
| rbg-Size | ENUMERATED {config2} | OPTIONAL, - |

```
- Need S
    powerControlLoopToUse ENUMERATED {n0, n1},
    p0-PUSCH-Alpha P0-PUSCH-AlphaSetId,
```

| | |
|---|---|
| transformPrecoder | ENUMERATED {enabled, disabled} |

OPTIONAL, -- Need S
nrofHARQ-Processes INTEGER(1..17),

| | |
|---|---|
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |

```
    sym2, sym7, sym1x14, sym2x14, sym4x14, sym5x14, sym8x14, sym10x14,
sym17x14, sym20x14,
    sym32x14, sym40x14, sym64x14, sym80x14, sym128x14, sym170x14,
sym256x14, sym320x14, sym512x14,
    sym640x14, sym1024x14, sym1280x14, sym2560x14, sym5120x14,
    sym6, sym1x12, sym2x12, sym4x12, sym5x12, sym8x12, sym10x12,
sym17x12, sym20x12, sym32x12,
    sym40x12, sym64x12, sym80x12, sym128x12, sym170x12, sym256x12,
sym320x12, sym512x12, sym640x12,
    sym1280x12, sym2560x12
    },
```

| | | |
|---|---|---|
| configuredGrantTimer | INTEGER (1..64) | OPTIONAL, |

```
-- Need R
    rrc-ConfiguredUplinkGrant SEQUENCE {
      timeDomainOffset INTEGER (0..5119),
      timeDomainAllocation INTEGER (0..16),
      frequencyDomainAllocation BIT STRING (SIZE(18)),
      antennaPort INTEGER (0..31),
```

| | | |
|---|---|---|
| dmrs-SeqInitialization | INTEGER (0..1) | OPTIONAL, - |

- Need R
precodingAndNumberOfLayers INTEGER (0..63),

| | | |
|---|---|---|
| srs-ResourceIndicator | INTEGER (0..16) | OPTIONAL, |

-- Need R

| | |
|---|---|
| mcsAndTBS | INTEGER (0..31), |

| | |
|---|---|
| frequencyHoppingOffset | INTEGER (1.. |

maxNrofPhysicalResourceBlocks-1) OPTIONAL, -- Need R

| | |
|---|---|
| pathlossReferenceIndex | INTEGER (0..maxNrofPUSCH- |

PathlossReferenceRSs-1),
...

| | |
|---|---|
| } | OPTIONAL, -- Need R |

```
    ...
  }
```

The DMRS antenna port for PUSCH transmission may be the same as the antenna port for SRS transmission. PUSCH transmission may follow a codebook-based transmission method and a non-codebook-based transmission method, respectively, depending on whether the value of txConfig in push-Config of Table 7 above, which is higher-signaling, is “codebook” or “nonCodebook”. A PUSCH transmission may be dynamically scheduled through DCI format 0_0 or 0_1 or be semi-statically configured by the configured grant. If the terminal is indicated to schedule PUSCH transmission through DCI format 0_0, the terminal may perform beam configuration for PUSCH transmission using the pucch-spatialRelationInfoID corresponding to terminal-specific (UE-specific or UE-dedicated) PUCCH resource having the lowest ID in the activated uplink bandwidth part (BWP) in the serving cell. The PUSCH transmission may be performed based on a single antenna port. The terminal may not expect scheduling for PUSCH transmission through DCI format 0_0 in a BWP in which PUCCH resource including pucch-spatialRelationInfo is not configured. If the terminal has not received configuration of txConfig in push-Config of Table 11 below, the terminal may not expect to be scheduled through DCI format 0_1.

TABLE 11
PUSCH-Config

| | |
|---|---|
| PUSCH-Config ::= | SEQUENCE { |

| | |
|---|---|
| dataScramblingIdentityPUSCH | INTEGER (0..1023) OPTIONAL, |

-- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |

UplinkConfig } OPTIONAL, -- Need M

| | |
|---|---|
| dmrs-UplinkForPUSCH-MappingTypeB | SetupRelease { DMRS- |

UplinkConfig } OPTIONAL, -- Need M

| | |
|---|---|
| pusch-PowerControl | PUSCH-PowerControl OPTIONAL, |

-- Need M

| | |
|---|---|
| frequencyHopping | ENUMERATED {intraSlot, interSlot} |

OPTIONAL, -- Need S
frequencyHoppingOffsetLists SEQUENCE (SIZE (1..4)) OF INTEGER
(1..maxNrofPhysicalResourceBlocks-1) OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

TimeDomainResourceAllocationList } OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

```
OPTIONAL, -- Need S
    codebookSubset ENUMERATED {fullyAndPartialAndNonCoherent,
partialAndNonCoherent,nonCoherent}
      OPTIONAL, -- Cond codebookBased
```

| | | |
|---|---|---|
| maxRank | INTEGER (1..4) | OPTIONAL, -- Cond |

codebookBased

| | | |
|---|---|---|
| rbg-Size | ENUMERATED { config2} | OPTIONAL, - |

- Need S

| | | |
|---|---|---|
| uci-OnPUSCH | SetupRelease { UCI-OnPUSCH} | OPTIONAL, |

-- Need M

| | | |
|---|---|---|
| tp-pi2BPSK | ENUMERATED { enabled} | OPTIONAL, |

```
-- Need S
    ...
  }
```

Codebook-based PUSCH transmission may be dynamically scheduled through DCI format 0_0 or 0_1 and may be semi-statically operated by the configured grant. If the PUSCH transmission is dynamically scheduled by codebook-based PUSCH DCI format 0_1 or semi-statically configured by configured grant, the terminal may determine, based on an SRS resource indicator (SRI), a transmission precoding matrix indicator (TPMI), and a transmission rank (number of PUSCH transmission layers), a precoder for PUSCH transmission. The SRI may be given through a field SRS resource indicator in the DCI or configured through srs-ResourceIndicator which is higher-layer signaling. The terminal may receive a configuration of at least one SRS resource, e.g., up to two SRS resources, upon codebook-based PUSCH transmission. When the terminal receives the SRI through the DCI, the SRS resource indicated by the corresponding SRI may mean the SRS resource corresponding to the SRI among SRS resources transmitted prior to the PDCCH including the SRI. The TPMI and transmission rank may be given through the field precoding information and number of layers in the DCI or configured through precodingAndNumberOfLayers, which is higher-layer signaling. The TPMI may be used to indicate the precoder applied to PUSCH transmission.

The precoder to be used for PUSCH transmission may be selected from an uplink codebook having the same number of antenna ports as the nrofSRS-Ports value in SRS-Config, which is higher-layer signaling. In codebook-based PUSCH transmission, the terminal may determine a codebook subset, based on the TPMI and codebookSubset in push-Config, which is higher-layer signaling. The codebookSubset in push-Config, which is higher-layer signaling, may be configured to be one of “fullyAndPartialAndNonCoherent”, “partialAndNonCoherent”, or “noncoherent”, based on the UE capability reported to the base station by the terminal.

If the terminal reports “partialAndNonCoherent” as the UE capability, the terminal may not expect the value of codebookSubset, which is higher-layer signaling, to be configured to be “fullyAndPartialAndNonCoherent”. If the terminal reports “noncoherent” as the UE capability, the terminal may not expect the value of codebookSubset, which is higher-layer signaling, to be configured to be “fullyAndPartialAndNonCoherent” or “partialAndNonCoherent”. If nrofSRS-Ports in SRS-ResourceSet, which is higher-layer signaling, indicates two SRS antenna ports, the terminal may not expect the value of codebookSubset, which is higher-layer signaling, to be configured to be “partialAndNonCoherent”.

The terminal may receive a configuration of one SRS resource set, in which the value of usage in SRS-ResourceSet, which is higher-layer signaling, is configured to be “codebook”, and one SRS resource in the corresponding SRS resource set may be indicated through the SRI. If several SRS resources are configured in the SRS resource set in which the usage value in the SRS-ResourceSet, which is higher-layer signaling, is configured to be “codebook”, the terminal may expect the same value to be set for all SRS resources in the nrofSRS-Ports value in the SRS-Resource which is higher-layer signaling.

The terminal may transmit, to the base station, one or multiple SRS resources included in the SRS resource set in which the value of usage is configured to be “codebook” according to higher-layer signaling, and the base station may select one of the SRS resources transmitted by the terminal and indicate the terminal to perform PUSCH transmission using transmission beam information on the corresponding SRS resource. In codebook-based PUSCH transmission, the SRI is used as information for selecting an index of one SRS resource and may be included in the DCI. The base station may include information indicating the TPMI and rank to be used by the terminal for PUSCH transmission in the DCI and transmit the same. The terminal may perform PUSCH transmission by applying the precoder indicated by the rank and TPMI indicated by the transmission beam of the SRS resource using the SRS resource indicated by the SRI.

on-codebook-based PUSCH transmission may be dynamically scheduled through DCI format 0 0 or 0_1 or be semi-statically operated by the configured grant. When at least one SRS resource is configured in the SRS resource set in which the value of usage in the SRS-ResourceSet, which is higher-layer signaling, is configured to be “nonCodebook”, the terminal may be scheduled for non-codebook based PUSCH transmission through DCI format 0_1.

For the SRS resource set in which the value of usage in the SRS-ResourceSet, which is higher-layer signaling, is configured to be “nonCodebook”, the terminal may receive configuration of a non-zero power (NZP) CSI-RS resource associated with one SRS resource set. The terminal may perform calculation for the precoder for SRS transmission through measurement of the NZP CSI-RS resource configured in association with the SRS resource set. If the difference between the last received symbol of the aperiodic NZP CSI-RS resource associated with the SRS resource set and the first symbol of aperiodic SRS transmission in the terminal is less than specific symbols (e.g., 42 symbols), the terminal may not expect that information about the precoder for SRS transmission is updated.

When the value of resourceType in SRS-ResourceSet, which is higher-layer signaling, is configured to be “aperiodic”, the NZP CSI-RS associated with the SRS-ResourceSet may be indicated by an SRS request, which is a field in DCI format 0_1 or 1_1. If the NZP CSI-RS resource associated with the SRS-ResourceSet is an aperiodic NZP CSI resource and the value of the field SRS request in DCI format 0_1 or 1_1 is not “00”, this indicates that the NZP CSI-RS associated with the SRS-ResourceSet is present. The DCI may not indicate cross carrier or cross BWP scheduling. If the value of the SRS request indicates the presence of the NZP CSI-RS, the NZP CSI-RS may be positioned in the slot in which the PDCCH including the SRS request field is transmitted. TCI states configured in the scheduled subcarrier may not be configured to be QCL-typeD.

If a periodic or semi-persistent SRS resource set is configured, the NZP CSI-RS associated with the SRS resource set may be indicated through associatedCSI-RS in the SRS-ResourceSet, which is higher-layer signaling. For non-codebook-based transmission, the terminal may not expect spatialRelationInfo, which is higher-layer signaling for SRS resource, and associatedCSI-RS in SRS-ResourceSet, which is higher-layer signaling, to be configured together.

When multiple SRS resources are configured for the terminal, the terminal may determine, based on the SRI indicated by the base station, the precoder and transmission rank to be applied to PUSCH transmission. The SRI may be indicated through a field SRS resource indicator in the DCI or may be configured through srs-ResourceIndicator which is higher-layer signaling. As with the above-described codebook-based PUSCH transmission, when the terminal receives the SRI through the DCI, the SRS resource indicated by the corresponding SRI may mean the SRS resource corresponding to the SRI among SRS resources transmitted prior to the PDCCH including the SRI. The terminal may use one or more SRS resources for SRS transmission. The maximum number of SRS resources and the maximum number of SRS resources that may be simultaneously transmitted in the same symbol within one SRS resource set may be determined by the UE capability reported to the base station by the terminal. The SRS resources transmitted simultaneously by the terminal may occupy the same RB. The terminal may configure one SRS port for each SRS resource. Only one SRS resource set in which the value of usage in the SRS-ResourceSet, which is higher-layer signaling, is configured to be “nonCodebook” may be configured, and up to 4 SRS resources may be configured for non-codebook-based PUSCH transmission.

The base station may transmit one NZP CSI-RS associated with the SRS resource set to the terminal, and the terminal may calculate the precoder to be used for transmission of one or more SRS resources in the SRS resource set based on the measurement result upon NZP CSI-RS reception. The terminal may apply the calculated precoder when transmitting one or more SRS resources in the SRS resource set having usage configured to be “nonCodebook” to the base station, and the base station may select one or more SRS resources among one or more SRS resources received. In non-codebook based PUSCH transmission, the SRI may indicate an index that may represent a combination of one or multiple SRS resources, and the SRI may be included in the DCI. The number of SRS resources indicated by the SRI transmitted by the base station may be the number of transmission layers of the PUSCH. The terminal may apply the precoder applied to SRS resource transmission to each layer and transmit the PUSCH.

The 5G system may support two types (e.g., PUSCH repeated transmission type A and PUSCH repeated transmission type B) of repeated transmission methods of uplink data channel and TB processing over multi-slot PUSCH (TBoMS) that transmits a single TB over multi-slot PUSCH. The terminal may receive a configuration of either PUSCH repeated transmission type A or B through higher-layer signaling. The terminal may receive a configuration of a numberOfSlotsTBOMS′ through the resource allocation table and transmit the TBoMS.

### PUSCH Repeated Transmission Type A

As described above, as the time domain resource allocation method in one slot, the start symbol and length of the uplink data channel may be transmitted, and the base station may transmit the number of repeated transmissions to the terminal through higher-layer signaling (e.g., RRC signaling) or L1 signaling (e.g., DCI). To determine the TBS, the number N of the slots configured as numberOfSlotsTBoMS may be 1.

The terminal may repeatedly transmit uplink data channels, which are identical in start symbol and length to the uplink data channel configured above, in consecutive slots, based on the number of repeated transmissions received from the base station. When at least one symbol in the slot for uplink data channel repeated transmission configured to the UE or the slot configured to the UE in the downlink by the base station is configured in the downlink, the terminal may omit uplink data channel transmission in the corresponding slot. For example, the terminal may not transmit uplink data channel within the number of repeated transmissions of uplink data channel. However, the terminal supporting release (Rel)-17 uplink data repeated transmission may determine that the slot capable of uplink data repeated transmission is an available slot, and count the number of transmissions upon uplink data channel repeated transmission for the slot determined to be an available slot. When the uplink data channel repeated transmission determined to be an available slot is omitted, the transmission may be postponed, and then, may be repeatedly transmitted through a transmittable slot. By using Table 12 below, a redundancy version may be applied according to the redundancy version pattern configured for each n^{th} PUSCH transmission occasion.

### PUSCH Repeated Transmission Type B

As described above, as the time domain resource allocation method in one slot, the start symbol and length of the uplink data channel may be transmitted, and the base station may transmit the number of repeated transmissions, numberofrepetitions, to the terminal through higher-layer signaling (e.g., RRC signaling) or L1 signaling (e.g., DCI). To determine the TBS, the number N of the slots configured as numberOfSlots TBoMS is 1.

The nominal repetition of the uplink data channel may be determined as follows based on the start symbol and length of the uplink data channel configured above. Nominal repetition indicates the resources of the symbols configured by the base station for repeated PUSCH transmission, and the terminal may determine resources available for uplink in the configured nominal repetition. In this case, the slot where the n^{th} nominal repetition starts may be given by

$${K}_{s} + [ \frac{S + n \cdot L}{{N}_{symb}^{slot}} ] ,$$

and the symbol where the nominal repetition starts in the start slot may be given by mod (S+n·L, N_{symb}^{slot}). The slot where the n^{th} nominal repetition ends may be given by

$${K}_{s} + [ \frac{S + ( n + 1 ) \cdot L - 1}{{N}_{symb}^{slot}} ]$$

and the symbol where the nominal repetition ends in the last slot may be given by mod (S+(n+1)·L−1, N_{symb}^{slot}). n=0, . . . , numberofrepetitions−1, S may indicate the start symbol of the configured uplink data channel, and L may indicate the symbol length of the configured uplink data channel. Kₛ may indicate the slot in which PUSCH transmission starts, and N_{symb}^{slot} may indicate the number of symbols per slot.
The terminal may determine an invalid symbol for PUSCH repeated transmission type B. The symbol configured as downlink by tdd-UL-DL-ConfigurationCommon or tdd-UL-DL-ConfigurationDedicated may be determined to be an invalid symbol for PUSCH repeated transmission type B. Additionally, the invalid symbol may be configured based on the higher-layer parameter (e.g., InvalidSymbolPattern). For example, as the higher-layer parameter (e.g., InvalidSymbolPattern) provides a symbol level bitmap over one or two slots, an invalid symbol may be configured. In the bitmap, the indication “1” in the bitmap may indicate an invalid symbol. Additionally, the periodicity and pattern of the bitmap may be configured through the higher-layer parameter (e.g., periodicityAndPattern). If the higher-layer parameter (e.g., InvalidSymbolPattern) is configured and InvalidSymbolPatternIndicator-ForDCIFormat0_1 or InvalidSymbolPatternIndicator-ForDCIFormat0_2 parameter indicates 1, the terminal may apply the invalid symbol pattern and, if it indicates 0, the terminal may not apply the invalid symbol pattern. Alternatively, if the higher-layer parameter (e.g., InvalidSymbolPattern) is configured and InvalidSymbolPatternIndicator-ForDCIFormat0_1 or InvalidSymbolPatternIndicator-ForDCIFormat0_2 parameter is not configured, the terminal may apply the invalid symbol pattern.

After the invalid symbol is determined in each nominal repetition, the terminal may consider symbols other than the determined invalid symbol as valid symbols. If each nominal repetition includes one or more valid symbols, the nominal repetition may include one or more actual repetitions. Each actual repetition may mean the symbol actually used for PUSCH repeated transmission among the symbols configured in the configured nominal repetition, and may include consecutive sets of valid symbols that may be used for PUSCH repeated transmission type B in one slot. When the actual repetition having one symbol is configured to be valid except a case where the symbol length L of the configured uplink data channel is 1, the terminal may omit the actual repetition transmission. B using Table 12 below, a redundancy version may be applied according to the redundancy version pattern set for each n^{th} actual repetition.

### TB Processing Over Multiple Slots (TBoMS)

As described above, as the time domain resource allocation method in one slot, the start symbol and length of the uplink data channel may be transmitted, and the base station may transmit the number of repeated transmissions to the terminal through higher-layer signaling (e.g., RRC signaling) or L1 signaling (e.g., DCI). In an embodiment, the TBS may be determined using the N value not less than 1, which is the number of slots configured as numberOfSlotsTBoMS.

The terminal may transmit uplink data channels, which are identical in start symbol and length to the configured uplink data channel, in consecutive slots, based on the number of repeated transmissions and the number of slots for determining the TBS, received from the base station. When at least one symbol in the slot for uplink data channel repeated transmission configured for the terminal or the slot configured to the terminal in the downlink by the base station is configured in the downlink, the terminal may omit uplink data channel transmission in the corresponding slot. For example, the symbol may be included in the number of uplink data channel repeated transmissions, but may not be transmitted.

However, the terminal supporting Rel-17 uplink data repeated transmission may determine that the slot capable of uplink data repeated transmission is an available slot, and count the number of transmissions upon uplink data channel repeated transmission for the slot determined to be an available slot. When the uplink data channel repeated transmission determined to be an available slot is omitted, it may be postponed, and then, may be repeatedly transmitted through a transmittable slot. By using Table 12 below, a redundancy version may be applied according to the redundancy version pattern configured for each n^{th} PUSCH transmission occasion.

TABLE 12

| rv_{id} indicated | rv_{id} to be applied to n^{th} transmission occasion (repetition Type A) or TB | | | |
|---|---|---|---|---|
| by the DCI | processing over multiple slots) or n^{th} actual repetition (repetition Type B) | | | |
| scheduling | ((n − n mod N))/N) | ((n − (n mod N))/N) | ((n − (n mod N))N) | ((n − (n mode N))/N) |
| the PUSCH | mod 4 = 0 | mod 4 = 0 | mod 4 = 0 | mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Herein, if the terminal receives a configuration of AvailableSlotCounting as “enable”, the terminal may determine the available slot, based on tdd-UL-DL-ConfigurationCommon, tdd-UL-DL-ConfigurationDedicated, ssb-PositionsInBurst, and a time domain resource allocation (TDRA) information field value, for type A PUSCH repeated transmission and TBoMS PUSCH transmission. In other words, when at least one symbol configured with the TDRA for PUSCH in the slot for PUSCH transmission overlaps at least one symbol for other purposes than uplink transmission, the slot may be determined to be an unavailable slot.

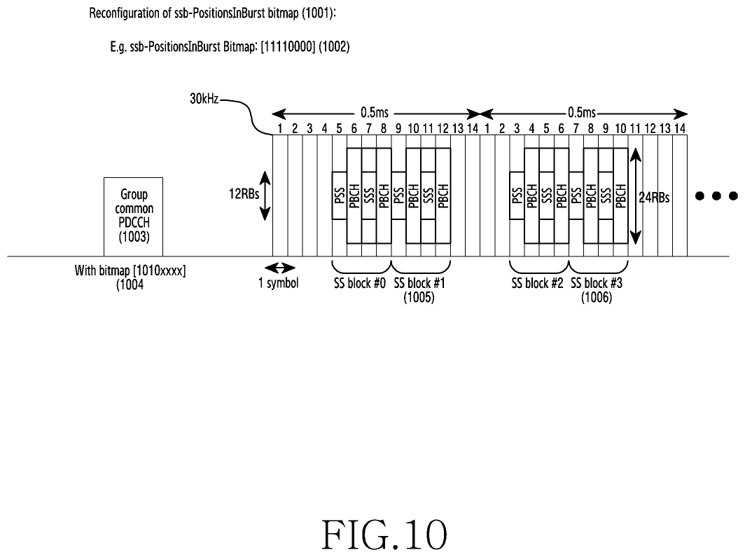

FIG. 10 illustrates a method for reconfiguring SSB transmission through dynamic signaling of a wireless communication system according to an embodiment.

Referring to FIG. 10, the terminal may receive configuration of ssb-PositionsInBurst=“11110000” (1002) through higher-layer signaling (SIB1 or ServingCellConfigCommon) from a base station, a maximum of two synchronization signal blocks at a SCS of 30 kHz may be transmitted within 0.5 ms (or corresponding to a length of one slot when one slot includes 14 OFDM symbols), and accordingly, the terminal may receive four synchronization signal blocks (SS blocks) within 1 ms (or corresponding to a length of two slots when one slot includes 14 OFDM symbols). In this case, to reduce SS block transmission density to save energy, the base station may broadcast bitmap “1010xxxx” (1004) through group/cell common DCI 1003 having a network energy saving-radio network temporary identifier (nwes-RNTI) (or es-RNTI) to reconfigure SS block transmission configuration information. In this case, transmission of SSblock #1 1005 and SSblock #3 1006 may be canceled based on the bitmap 1004 configured through the group/cell common DCI. FIG. 10 illustrates a method 1001 for reconfiguring SS block transmission through bitmap-based group/cell common DCI.

In addition, the base station may reconfigure SS block-periodicity configured through higher-layer signaling through the group/cell common DCI. In addition, the base station may additionally configure time information for indicating a time point for applying the group/cell common DCI, and transmit the SS block through SS block transmission information reconfigured by the group/cell common DCI fur a configured timer. Thereafter, when the timer ends, the base station may operate by the SS block transmission information configured through the existing higher-layer signaling. This may switch a configuration from a normal mode to an energy saving mode through the timer, and may allow reconfiguration of the SS block transmission information according thereto. In another method, the base station may configure, for the terminal, an application time point and duration of the SS block configuration information reconfigured through the group/cell common DCI as an offset and duration information. In this case, the terminal may not monitor the SS block for the duration from a time point at which the offset is applied from the moment the group/cell common DCI is received.

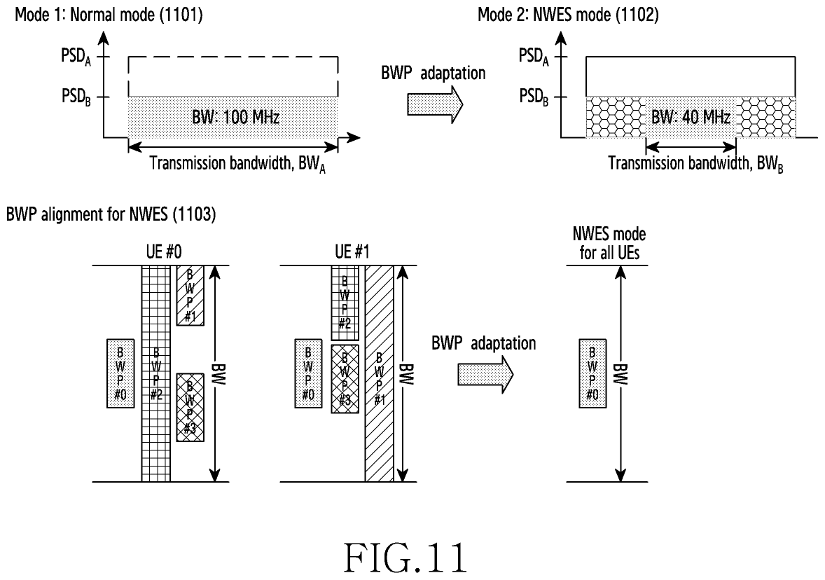

FIG. 11 illustrates a method for reconfiguring a BWP and a BW through dynamic signaling of a wireless communication system according to an embodiment.

Referring to FIG. 11, the terminal may operate as a BWP or a BW activated through higher-layer signaling and L1 signaling from the base station (1101). For example, the terminal may operate through a full BW of 100 MHz at fixed power PSDB. In this case, for energy saving, the base station may adjust the BW and the BWP to cause the terminal to activate a narrower BW of 40 MHz while having the same power PSDB (1102). In this case, adjusting the BW or the BWP by the base station to save energy may be configured so that the BWP and BW configurations configured to be UE-specifically through group common DCI and cell specific DCI are adjusted to be identical to each other (1103). For example, UE #0 and UE #1 may have configurations and positions of different BWPs. In this case, to save energy by reducing the used BW, the base station may configure the BWs and BWPs of all terminals to be identical and a single BW and BWP. In this case, one or more BWPs or BWs may be configured in the energy saving operation, and the same may be used to configure a UE group-specific BWP.

Herein, higher-layer signaling corresponds to at least one of MIB, SIB or SIB X (X=1, 2, . . . ), RRC or medium access control (MAC) control element (CE).

In addition, L1 signaling may be signaling corresponding to at least one of signaling methods using one or more of the physical layer channels or signalings including PDCCH, DCI, UE-specific DCI, group common DCI, common DCI, scheduling DCI used for scheduling downlink or uplink data, non-scheduling DCI that is not used for scheduling downlink or uplink data, PUCCH, or uplink control information (UCI).

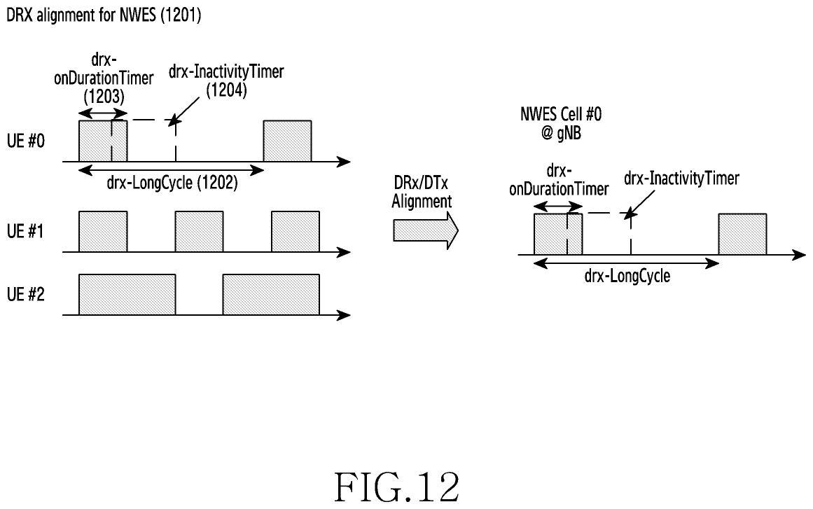

FIG. 12 illustrates a method for reconfiguring DRX through dynamic signaling of a wireless communication system according to an embodiment.

Referring to FIG. 12, the base station may configure UE-specific DRX through higher-layer signaling. For example, the respective terminals may receive different drx-LongCycles 1202 or drx-ShortCycles, drx-onDurationTimers 1203, and drx-Inactivity Timers 1204. Thereafter, the base station may configure a UE-specific DRX configuration to be a UE group-specific DRX configuration or a cell-specific DRX configuration through L1 signaling to achieve energy saving (1201). Accordingly, for energy saving, the base station may achieve the same effect as that of saving power through DRX by the terminal.

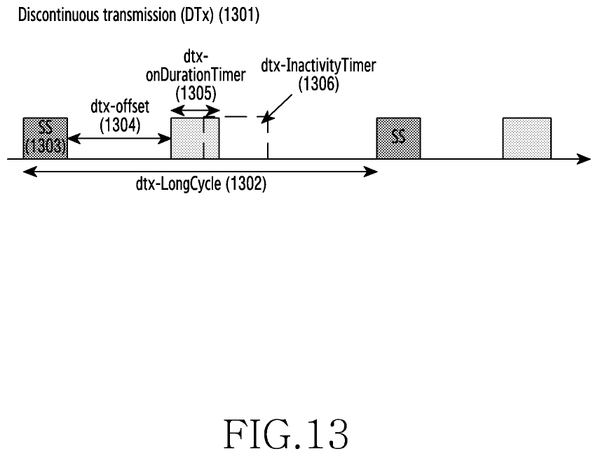

FIG. 13 illustrates a DTx method for energy saving of a base station according to an embodiment.

Referring to FIG. 13, for energy saving, the base station may configure discontinuous transmission (DTx) through higher-layer signaling (new SIB) for DTx or RRC signaling) and L1 signaling (DCI). In this case, for the DTx operation, the base station may configure dtx-onDurationTimer 1305 for transmitting a PDCCH for scheduling a DL SCH or a reference signal for measuring RRM measurement, beam management, pathloss, etc., dtx-InactivityTimer 1306 for receiving a PDSCH after receiving the PDCCH for scheduling the DL SCH, dtx-offset 1304 for configuring an offset between a synchronization signal (SS) 1303 for synchronization before the dtx-onDurationTimer and dtx-onDurationTimer after the configuration information SS, and dtx-(Long) Cycle 1302 for DTx periodic operation based on the configuration information. In this case, multiple dtx-cycles may be configured as a long cycle and a short cycle. During the operation of DTx, the base station considers the state of a transmission terminal as an off (or inactive) state, accordingly, may not transmit a DL CCH, an SCH, and a DL RS. That is, during the DTX operation, the base station may transmit a downlink (PDCCH, PDSCH, RS, etc.) only during the SS, dtx-onDurationTimer, and dtx-InactivityTimer. In this case, according to additional information of the configured SS, the number of SS-gapbetweenBursts or SS bursts may be configured.

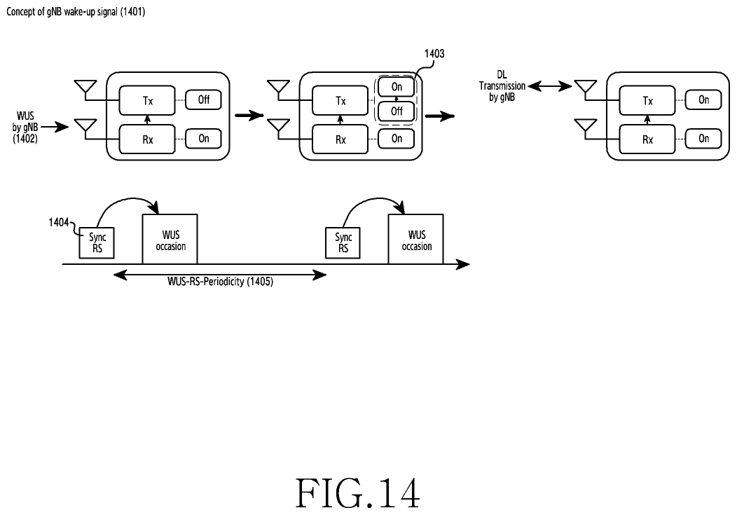

FIG. 14 illustrates an example of describing an operation of a base station according to a gNB wake-up signal according to an embodiment.

Referring to FIG. 14, for energy saving, the base station may maintain the state of a transmitter terminal to be an off (or inactive) state while the base station is in an active state (or sleep mode). Thereafter, the base station may receive a gNB wake-up signal 1402 for activating a sleep mode of the base station from the terminal. Thereafter, when receiving a wake-up signal (WUS) from the terminal through an Rx terminal, the base station may change the state of the Tx terminal to be on (or active) state (1403). Thereafter, the base station may perform downlink transmission for the terminal. In this case, the base station may perform synchronization and control and data transmission after Tx-on. In addition, various uplink signals, for example, PRACH, scheduling request (SR) PUCCH, PUCCH including Ack, etc., may be considered as a gNB WUS. Through the method, the base station can save energy and improve latency.

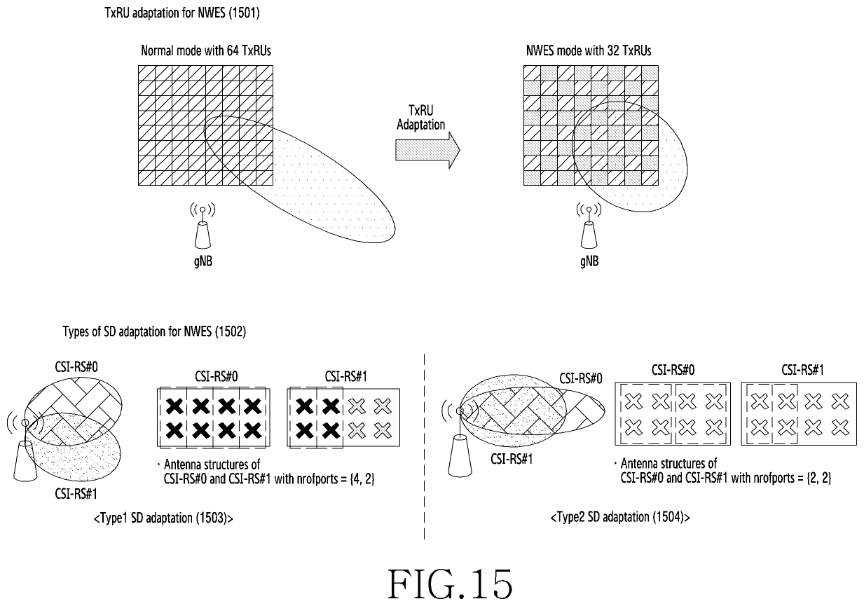

In this case, the base station may configure WUS occasion for receiving the gNB WUS and a sync RS for synchronization before the terminal transmits the gNB WUS. In this case, as the sync RS, an SSB, TRS, light SSB (PSS+SSS), consecutive SSBs, or new RS (continuous PSS+SSS), etc. may be considered, and as the WUS, a PRACH, PUCCH with SR, sequence-based signal, etc. may be considered. The SyncRS 1404 for activating the inactive mode of the base station for energy saving by the terminal and the WUS occasion for receiving the WUS may be repeatedly transmitted by WUS-RS periodicity 1405. In FIG. 15, an embodiment is described according to an example of 1-to-1 mapping of the sync and the WUS occasion, but the disclosure is not limited thereto. For example, the sync and the WUS occasion may be mapped to each other according to N-to-1 mapping, 1-to-N mapping, or N-to-M mapping.

FIG. 15 illustrates an antenna adaptation method of a base station for energy saving of a wireless communication system according to an embodiment.

Referring to FIG. 15, the base station may adjust a Tx antenna port per radio unit (RU) for energy saving (network energy savings (NWES)) (1501). For example, most of the energy consumption of the base station is occupied by the PA of the base station, and thus, the base station may turn off the Tx antenna for energy saving. In this case, to determine whether the Tx antenna can be turned off, the base station may refer to/use reference signal received power (RSRP), a channel quality indicator (CQI), a reference signal received quality (RSRQ), or the like of the terminal. The base station may adjust the number of activated Tx antennas for each UE group or UE and perform Tx transmission. In this case, the base station may configure, for the terminal through higher-layer signaling (e.g., RRC signaling) or DCI signaling, information including one or more of beam information according to antenna on/off or reference signal information (e.g., one or more among a CSI resource, a CSI resource set, or a CSI report). The base station may configure different antenna information for each BWP and reconfigure antenna information according to a BWP change. The base station may receive CSI feedback from the terminal to determine whether SD adaptation is possible. The base station may determine SD adaptation (based on CSI feedback). The base station may receive multi-feedback through antenna structure hypotheses of several antenna patterns for SD adaptation from the terminal.

More specifically, the base station may apply multiple types (e.g., two types) of SD adaptation for energy saving (1502). For example, the multiple types may include type 1 SD adaptation 1503 and type 2 SD adaptation 1504.

When the type 1 SD adaptation 1503 is applied, the base station may adapt the number of antenna ports while maintaining the number of physical antenna elements per antenna port (i.e., a logical port). In this case, RF characteristics (e.g., tx power, beam) per port may be identical. Accordingly, the terminal may perform measurement by combining CSI-RS of the same port during CSI measurement (e.g., layer 1-RSRP (L1-RSRP), layer 3-RSRP (L3-RSRP), etc.).

In another method, when the type 2 SD adaptation 1504 is applied, the base station may have the same number of antenna ports (i.e., logical ports), and turn on/off a physical antenna element per port (1504). In this case, the RF characteristic per port may vary. The terminal may distinguish from CSI-RSs of the same port during the CSI measurement and perform the measurement for each of the CSI-RSs. The base station can save energy through one or more of multiple types of SD adaptation methods including the two types of SD adaptation.

Through the methods according to an embodiment of the disclosure, the base station can reduce energy consumption. In addition, the methods according to an embodiment of the disclosure may be configured/used as a single method or may be simultaneously configured/used through combination of one or more thereof. As previously described, the disclosure provides a method for receiving CSI feedback from the terminal to perform SD adaptation to reduce energy consumption by the base station. One or multiple CSI resources and/or CSI resource sets and/or one or multiple CSI report configuration methods for receiving CSI feedback from the terminal by the base station may be provided. A thresholding-based CSI report method for reducing the overhead of reporting and CSI measurement of the terminal may be provided. Proper SD adaptation is applied for each terminal, and thus energy consumption can be reduced without deterioration of the coverage and service performance, whereby the CSI feedback overhead of the terminal can also be improved. In the disclosure, the expressions such as energy saving, energy consumption reduction, and reducing energy consumption can be interchangeably used, and can be understood to indicate the same meaning. Unless mentioned otherwise specifically, a CSI-RS resource configuration in the disclosure may include a CSI-RS resource set configuration. For example, the CSI-RS resource configuration may be performed based on the CSI-RS resource set configuration.

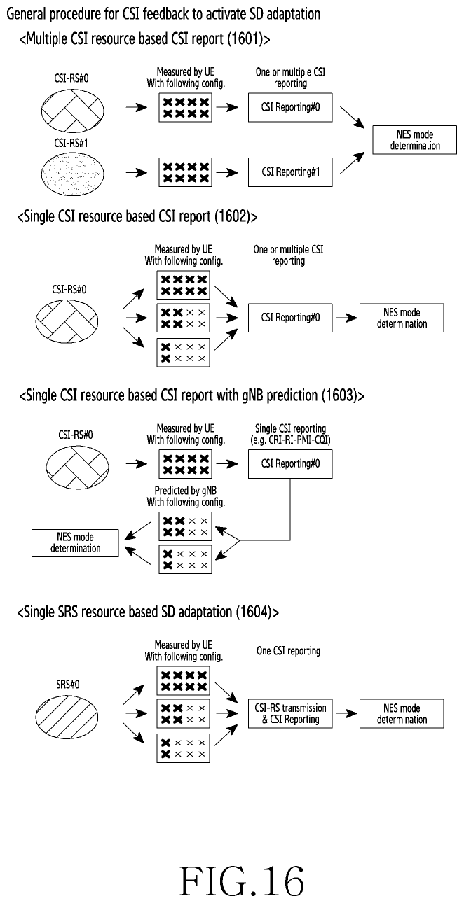

FIG. 16 illustrates a method for receiving terminal-specific CSI feedback for determining SD adaptation of a base station of a wireless communication system according to an embodiment.

Referring to FIG. 16, the base station may determine SD adaptation, based on terminal-specific CSI feedback. For example, this may be for energy saving, the base station may determine, based on the CSI feedback, an NES mode, and the determining of the NES mode may include determining SD adaptation. The base station may acquire CSI feedback for determining an antenna pattern appropriate/suitable for terminal-specific SD adaptation by using one of the methods below or a combination of one or more thereof.

### Method 3—Multiple CSI Resource Based CSI Report (1601)

In method 3 (1601) according to an embodiment of the disclosure, a multiple CSI reporting method through multiple CSI-RS measurement may be provided. For example, this may be energy saving of the base station.

The base station may configure, from the terminal, multiple CSI resource (and/or CSI resource set) and CSI report configuration having different antenna structures through higher-layer signaling. The terminal may measure different CSI-RSs and transmit CSI feedback through a CSI report through different PUCCHs or PUSCHs or the same PUCCH or PUSCH. The terminal may measure different CSI-RSs and acquire different pieces of CSI feedback. The terminal may transmit (multiple) CSI report based on different pieces of CSI feedback through the same PUCCH (or the same PUSCH), or may transmit same through different PUCCHs or PUSCHs, respectively. Thereafter, the base station may determine SD adaptation for energy saving through the multiple CSI reports.

For example, the base station may configure a CSI resource corresponding to CSI-RS #0 and a CSI resource corresponding to CSI-RS #1 through higher-layer signaling. The terminal may report CSI reporting #0 including CSI measurement obtained based on CSI-RS #0, and report CSI reporting #1 including CSI measurement obtained based on CSI-RS #1. The base station may perform NES mode determination based on the reported CSI reporting #0 and CSI reporting #1.

In method 3 (1601), the base station may receive CSI feedback for multiple SD adaptability. Method 3 (1601) is suitable for determining type 2 SD adaptation having different RF characteristics. The base station may perform multiple CSI-RS transmissions and multiple CSI report receptions. The base station may configure a CSI report for each of the multiple CSI-RS transmissions and multiple CSI reporting for multiple CSI reports. The terminal may perform measurement multiple times and report multiple CSI reports.

### Method 4—Single CSI Resource Based CSI Report (1602)

In method 4 (1602), a multiple CSI report method through single CSI-RS measurement may be provided. For example, this may be for energy saving of the base station.

The base station may configure, for the terminal through higher-layer signaling, a CSI report configuration including one or multiple antenna structure configurations and a single CSI resource configuration for SD adaptation. The base station may transmit a single CSI-RS to receive CSI feedback for SD adaptation. The CSI-RS may be a CSI-RS for one or multiple CSI report configurations. With respect to the single CSI-RS transmission, the terminal may perform, based on the configured CSI report configuration, measurement several times in consideration of a CSI-RS pattern and several antenna structure assumptions (which may correspond to multiple antenna structure configurations). Thereafter, the terminal may report, through one or multiple PUCCHs or one or multiple PUSCHs, a measurement report acquired through the several antenna structure assumptions. The terminal may measure, based on the one or multiple CSI report configurations, the single CSI-RS several times and acquire multiple pieces of CSI feedback. The terminal may transmit the (multiple) CSI report based on the multiple pieces of CSI feedback through the same PUCCH or PUSCH, or may transmit the same through different PUCCHs (or different PUSCHs), respectively. The base station may apply, based on the CSI report received from the terminal, SD adaptation suitable for the terminal.

For example, the base station may configure a CSI resource corresponding to CSI-RS #0 through higher-layer signaling. The terminal may report CSI reporting #0 including multiple CSI measurements measured based on CSI-RS #0. The base station may perform NES mode determination based on the reported CSI reporting #0.

In method 4 (1602), the base station may determine SD adaptation for energy saving. Method 4 (1602) may be applied for type 1 SD adaptation having the RF characteristic remaining same. 4 (1602), The overhead for the CSI-RS transmission can be reduced upon the single CSI-RS transmission. 4 (1602), The terminal may perform CSI reporting in consideration of multiple antenna patterns.

Method 5—Single CSI Resource Based CSI Report with gNB Prediction (1603)

According to method 5 (1603), a CSI feedback prediction method in consideration of multiple antenna structures of the base station, for energy saving of the base station.

The base station may configure, for the terminal through higher-layer signaling, a single CSI resource configuration and a single CSI report configuration for SD adaptation. Thereafter, the base station may receive, based on the configured information, a CSI report from the terminal. The base station may perform CSI reporting prediction in consideration of several antenna patterns through the CSI report received from the terminal. For example, the terminal may report the entire channel matrix measured in performing CSI reporting, and the base station may perform CSI reporting prediction through the CSI report. The base station may configure a single CSI resource configuration and a single CSI report configuration for the terminal, and the terminal may report, based thereon, the single CSI report. For the singe CSI report, a single antenna pattern may have been considered. The base station may predict, based on the received single CSI report, CSI reporting for multiple antenna patterns. The base station may determine a terminal-specific antenna pattern of SD adaptation for energy saving. In method 5 (1603), the CSI report received from the terminal may include new information (for example, full or partial channel matrix), etc.

For example, the base station may configure a CSI resource corresponding to CSI-RS #0 through higher-layer signaling. The terminal may report CSI reporting #0 including the CSI measurement measured based on CSI-RS #0. CSI reporting #0 may be configured based on a specific ReportQuantity (for example, cri-RI-PMI-CQI or newly measured channel matrix). Alternatively, CSI reporting #0 may include one or more of the CQI. The base station may perform NES mode determination based on the reported CSI reporting #0.

In method 5 (1603), in the perspectives of both the base station and the terminal, the configuration and measurement overhead for the CSI report can be reduced.

### Method 6—Single SRS Resource Based SD Adaptation (1604)

According to method 6 (1604), an SD adaptation method through SRS measurement may be provided for energy saving of the base station.

The base station may configure a single SRS resource or multiple SRS resources (and/or SRS resource set) for SD adaptation through higher-layer signaling. The terminal may transmit an SRS according to configuration information. The base station may determine multiple antenna patterns for SD adaptation through the single SRS measurement.

As another method, the base station may determine antenna patterns for SD adaptation by measuring, based on different Rx antenna patterns, multiple SRS measurements, respectively. That is, the base station may determine multiple antenna patterns for SD adaptation through single SRS measurement acquired based on the single SRS resource. Alternatively, the base station may determine multiple antenna patterns for SD adaptation through multiple SRS measurements acquired based on the multiple SRS resources. The base station may receive CSI reporting from the terminal through the determined antenna pattern and re-identify the determined antenna pattern. The base station may fallback to SD adaptation having a full antenna pattern when L1-RSRP and/or CQI of the reported CSI report is low (for example, when L1-RSRP and/or CQI of the reported CSI report is less than or equal to a specific threshold/less than a specific threshold) through the re-identification. Otherwise (when L1-RSRP and/or CQI of the reported CSI report is not low (for example, when L1-RSRP and/or CQI of the reported CSI report is greater than or equal to a specific threshold/greater than a specific threshold)), the base station may apply terminal-specific SD adaptation by using the antenna pattern determined in advance through the SRS measurement. The base station may determine an antenna pattern for terminal-specific SD adaptation through the SRS measurement.

For example, the base station may configure an SRS resource corresponding to SRS #0 through higher-layer signaling. The terminal may transmit SRS #0 based on the SRS resource. The base station may determine, based on SRS #0, one or multiple antenna patterns. The base station may transmit the CSI-RS, and may receive, based on the determined antenna patterns, CSI reporting corresponding to the CSI-RS. In addition, the base station may determine an NES mode.

In method 6 (1604), reciprocity between DL and UL may have been considered in, for example, a time division duplex (TDD) situation. 6 (1604), The base station may determine SD adaptation only upon the SRS reception without additional CSI transmission, and may thus determine SD adaptation while having a better energy efficiency. The terminal may perform SRS transmission according to an additional SRS configuration.

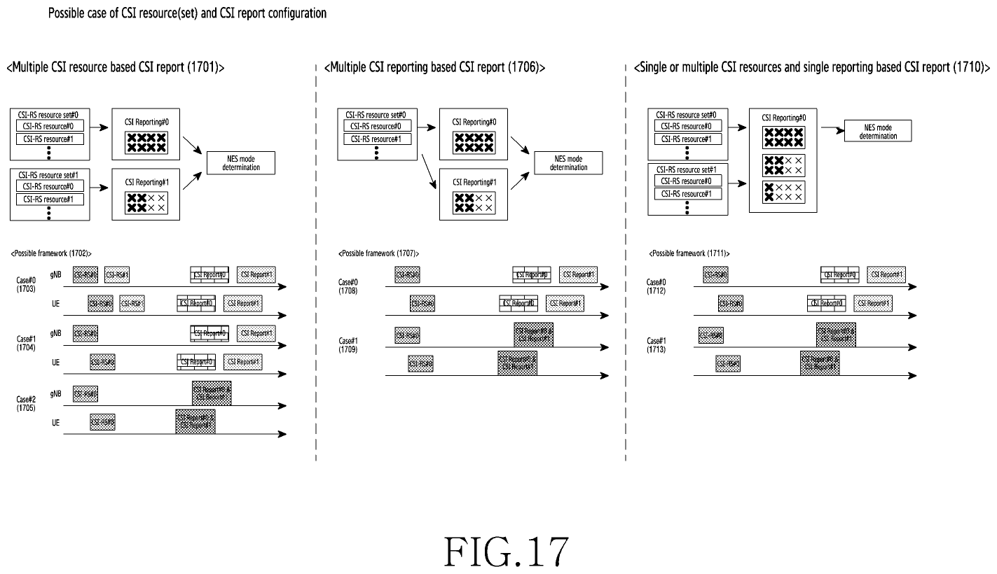

FIG. 17 illustrates a CSI resource/resource set/report configuration method for determining terminal-specific SD adaptation of a base station of a wireless communication system according to an embodiment.

Referring to FIG. 17, a CSI resource/resource set/report configuration method for determining, based on terminal-specific CSI feedback for energy saving, SD adaptation by the base station.

The base station may configure a CSI resource/resource set/report for determining an antenna pattern suitable for terminal-specific SD adaptation by one of the methods below or a combination thereof. The CSI resource/resource set/report configuration method may be applied and procedures of the SD adaptation determination method may be performed.

### Method 1—Multiple CSI Resource Based CSI Report (1701)

In method 1 (1701), multiple CSI-RS resource/resource sets and multiple CSI reports may be configured, for energy saving of the base station.

The base station may configure multiple CSI resources/resource sets through higher-layer signaling for the CSI report. The base station may configure multiple CSI reports for the CSI resource set. For example, each CSI report may have a single antenna structure hypothesis. The base station may perform NES mode determination based on the multiple CSI reports received from the terminal.

For example, the base station may configure CSI-RS resource set #0 and CSI-RS resource set #1 including at least CSI-RS reousrce #0 and CSI-RS resource #1, respectively. In addition, the base station may configure CSI Reporting #0 corresponding to CSI-RS resource set #0 and CSI Reporting #1 corresponding to CSI-RS resource set #1. CSI Reporting #0 and CSI Reporting #1 may have different antenna structure hypotheses, respectively. The base station may perform NES mode determination based on the multiple CSI reports (corresponding to CSI Reporting #0 and CSI Reporting #1) received from the terminal.

The base station and/or terminal may perform at least some of the operations below through the configuration of the multiple CSI resources/resource sets and multiple CSI reports.

### Step 1—Case #0

In step 1 (1703), a CSI-RS transmission/measurement and CSI reporting operation through a PUCCH/PUSCH may be performed based on the configuration of the multiple CSI resources/resource sets and multiple CSI reports in different resources.

The base station may configure, from the terminal, multiple CSI resources/resource sets and multiple SI reports through higher-layer signaling. Thereafter, the base station may transmit CSI-RSs having different CSI-RS patterns (for example, different CDM groups in different time/frequency resources, respectively. The terminal may measure each of the CSI-RSs transmitted from the base station to perform CSI reporting through different PUCCHs/PUSCHs.

For example, the base station may transmit configuration of a CSI resource/resource set corresponding to CSI-RS #0 and a CSI resource/resource set corresponding to CSI-RS #1 through higher-layer signaling, and the terminal may receive the same. The base station may transmit CSI-RS #0 and CSI-RS #1, and the terminal may receive, based on the configuration information, CSI-RS #0 and CSI-RS #1. The terminal may transmit, based on CSI-RS #0 and CSI-RS #1, CSI Report #0 and CSI Report #1 through different PUCCHs/PUSCHs, respectively, and the base station may receive the reports.

### Step 2—Case #1

In step 2 (1704), a CSI-RS transmission/measurement and CSI reporting operation may be performed based on the configuration of multiple CSI resources/resource sets and multiple CSI reports in the same resource through different PUCCHs/PUSCHs, respectively. Hereinafter, an identical resource (or the same resource) in the disclosure may be time and frequency resources (for example, time and frequency resources for CSI (measurement), time and frequency resources in which the CSI-RS is transmitted/mapped, CSI resources, etc.) configured in a specific time interval or slot.

The base station may configure, for the terminal, multiple CSI resources/resource sets through higher-layer signaling. Thereafter, the base station may transmit CSI-RS having multiple CSI-RS patterns (for example, different CDM groups) in the same resource. In this case, the different CSI-RS patterns may have different sub-set structures from each other. The terminal may measure the CSI-RS transmitted from the base station and transmit multiple CSI measurement values by performing CSI reporting through multiple PUCCHs/PUSCHs, respectively.

For example, the base station may transmit configuration information of a CSI resource/resource set corresponding to CSI-RS #0 through higher-layer signaling, and the terminal may receive the same. The base station may transmit CSI-RS #0, and the terminal may receive, based on the configuration information, CSI-RS #0. The terminal may transmit, based on CSI-RS #0, CSI Report #0 and CSI Report #1 through different PUCCHs/PUSCHs, respectively, and the base station may receive the reports.

### Step 3—Case #2

In step 3 (1705), a single CSI-RS transmission/measurement and CSI reporting operation through a single PUCCH/PUSCH may be performed based on the configuration of the multiple CSI resources/resource sets and multiple CSI reports.

The base station may configure, for the terminal, multiple CSI resources/resource sets and multiple CSI reports through higher-layer signaling. Thereafter, the base station may transmit CSI-RSs having multiple CSI-RS patterns (for example, different CDM groups) in the same resource. In this case, different CSI-RS patterns may have different sub-set structures from each other. The terminal may measure, based on multiple pieces of CSI report configuration information, a single CSI-RS transmitted from the base station, and transmit multiple CSI measurement values by performing CSI reporting through a single PUCCH/PIUSCH.

For example, the base station may transmit configuration information for a CSI resource/resource set corresponding to CSI-RS #0 through higher-layer signaling, and the terminal may receive the configuration information. The base station may transmit CSI-RS #0, and the terminal may receive, based on configuration information, CSI-RS #0. The terminal may transmit, based on CSI-RS #0, CSI Report #0 and CSI Report #1 through the same PUCCH/PUSCH, and the base station may receive the reports.

Through at least some of the operations, the base station may acquire, based on the configuration of the multiple CSI resources/resource sets and multiple CSI reports, a CSI report. That is, the base station may acquire, based on the configuration of the multiple resources/resource sets and multiple CSI reports, the CSI report.

### Method 2—Multiple CSI Report Based CSI Report (1706)

According to method 2 (1706), a method for configuring a single CSI-RS resource/resource set and multiple CSI reports is provided.

The base station may configure a single CSI resource/resource set through higher-layer signaling for the CSI report, and may configure multiple CSI reports for the CSI resource set. For example, each CSI report may have a single antenna structure hypothesis. The base station may perform NES mode determination based on the multiple CSI reports received from the terminal.

For example, the base station may configure CSI-RS resource set #0 at least including CSI-RS reousrce #0 and CSI-RS resource #1 and may configure CSI Reporting #0 and CSI Reporting #1 corresponding to CSI-RS resource set #0. CSI Reporting #0 and CSI Reporting #1 may include different antenna structure hypotheses, respectively. The base station may perform NES mode determination based on the multiple CSI reports (CSI Reporting #0 and CSI Reporting #1) received from the terminal.

The base station and/or the terminal may perform at least some of the operations through the configuration of the single CSI resource/resource set and the multiple CSI reports.

### Step 1—Case #0

In step 1 (1708), a CSI reporting operation through different PUCCHs/PUSCHs and CSI-RS transmission/measurement may be performed based on the configuration of the single CSI resource/resource set and the multiple CSI reports in the same resource.

The base station may configure the single CSI resource/resource set and the multiple CSI reports through higher-layer signaling. Thereafter, the base station may transmit a CSI-RS having multiple CSI-RS pattern (e.g., different CDM groups) in the same resource. In this case, different CSI-RS patterns may have different sub-set structures from each other. The terminal may measure the CSI-RS transmitted from the base station and transmit, through a CSI report, multiple CSI measurement values through different PUCCHs/PUSCHs, respectively.

For example, the base station may transmit configuration information of the CSI resource/resource set corresponding to CSI-RS #0 through higher-layer signaling, and the terminal may receive the same. The base station may transmit CSI-RS #0, and the terminal may receive, based on the configuration information, CSI-RS #0. The terminal may transmit, based on CSI-RS #0, CSI Report #0 and CSI Report #1 through different PUCCHs/PUSCHs, respectively, and the base station may receive the transmission.

### Step 2—Case #1

In step 2 (1709), a CSI reporting operation through a single PUCCH/PUSCH and single CSI-RS transmission/measurement based on the configuration of the multiple CSI reports and the single CSI resource/resource set. The base station may configure, for the terminal, multiple CSI reports and the single CSI resource/resource set through higher-layer signaling. Thereafter, the base station may transmit a CSI-RS having multiple CSI-RS patterns (e.g., different CDM groups) in the same resource. In this case, the different CSI-RS patterns may have different sub-set structures from each other. The terminal may measure, based on the multiple pieces of CSI report configuration information, a single CSI-RS transmitted from the base station and transmit, through a CSI report, multiple CSI measurement values through a single PUCCH/PUSCH.

For example, the base station may transmit configuration information of the CSI resource/resource set corresponding to CSI-RS #0 through higher-layer signaling, and the terminal may receive the same. The base station may transmit CSI-RS #0, and the terminal may receive, based on the configuration information, CSI-RS #0. The terminal may transmit, based on CSI-RS #0, CSI Report #0 and CSI Report #1 through the same PUCCH/PUSCH, and the base station may receive the same.

Through at least some of these operations, the base station may acquire, based on the configuration of the single CSI resource/resource set and the multiple CSI reports, the CSI report. That is, the base station may acquire, based on the configuration of the single CSI resource/resource set and the multiple CSI reports, the CSI report.

### Method 3—Single or Multiple CSI Resources and Single Reporting Based CSI Report (1710)

In method 3 (1710), a method for configuring a single CSI report having multiple antenna structure hypotheses and a single CSI-RS resource/resource set or multiple CSI-RS resources/resource sets is disclosed.

The base station may configure the single CSI resource/resource set or multiple CSI resources/resource sets and configure a single CSI report having multiple antenna structure hypotheses for the CSI resource set through higher-layer signaling. The base station may perform NES mode determination based on the single CSI report received from the terminal.

For example, the base station may configure CSI-RS resource set #0 and CSI-RS resource set #1 at least including CSI-RS resource #0 and CSI-RS resource set #1, respectively. In addition, the base station may configure CSI Reporting #0 corresponding to CSI-RS resource set #0 and CSI-RS resource set #1. CSI Reporting #0 may have multiple antenna structure hypotheses. The base station may perform NES mode determination based on the single CSI report (corresponding to CSI Reporting #0) received from the terminal.

The base station may perform at least some of the operations through the configuration of the CSI report having multiple antenna structure hypotheses and the single CSI resource/resource set.

### [Step 1]—Case #0

In step 1 (1712), a CSI reporting operation through different PUCCHs/PUSCHs and CSI-RS transmission/measurement may be performed based on the configuration of the single CSI resource/resource set and the single CSI report having multiple antenna structure hypotheses in the same resource. For example, the configuration of the CSI resort may include multiple antenna structure hypotheses.

The base station may configure a single CSI resource/resource set and a single CSI report having multiple antenna structure hypotheses through higher-layer signaling. Thereafter, the base station may transmit a CSI-RS having multiple CSI-RS patterns (e.g., different CDM groups) in the same resource. In this case, the different CSI-RS patterns may have different sub-set structures from each other. The terminal may measure a CSI-RS transmitted from the base station, and transmit, through a CSI report, multiple CSI measurement values through multiple PUCCHs/PUSCHs.

For example, the base station may transmit configuration information of the CSI resource/resource set corresponding to CSI-RS #0 through higher-layer signaling, and the terminal may receive the same. The base station may transmit CSI Reporting #0 including different antenna structure hypotheses (e.g., three), the terminal may receive the reporting. The base station may receive, based on configuration information, CSI-RS #0. The terminal may transmit, based on CSI-RS #0, CSI Report #0 and CSI Report #1 through multiple PUCCHs/PUSCHs, respectively, and the base station may receive the transmission. CSI Report #0 and CSI Report #1 may be based on CSI Reporting #0 configuration, and may correspond to different antenna structure hypotheses included in CSI Reporting #0, respectively.

### Step 2—Case #1

In step 2 (1713), a CSI reporting operation through a singling PUCCH/PUSCH and single CSI-RS transmission/measurement may be performed based on configuration of a single CSI resource/resource set and a single CSI report having multiple antenna structure hypotheses.

The base station may configure a single CSI report having multiple antenna structure hypotheses and a single CSI resource/resource set through higher-layer signaling. Thereafter, the base station may transmit a CSI-RS having multiple CSI-RS patterns (e.g., different CDM groups) in the same resource. In this case, the different CSI-RS patterns may have different sub-set structures form each other. The terminal may measure, based on the multiple pieces of CSI report configuration information (e.g., antenna structure hypotheses), the single CSI-RS transmitted from the base station, and transmit, via the CSI report, multiple CSI measurement values through a single PUCCH/PUSCH. In step 2, the base station may transmit one or more PUCCHs/PUSCHs in consideration of the size of the CSI report measured based on the multiple antenna structure hypotheses.

For example, the base station may transmit configuration information of a CSI resource/resource set corresponding to CSI-RS #0 through higher-layer signaling, and the terminal may receive the same. The base station may transmit CSI Report #0 including different antenna structure hypotheses (e.g., three), and the terminal may receive the report. The base station may transmit CSI-RS #0, and the terminal may receive, based on the configuration information, CSI-RS #0. The terminal may transmit, based on CSI-RS #0, CSI Report #0 and CSI Report #1 through the same PUCCH/PUSCH, and the base station may receive the transmission. CSI Report #0 and CSI Report #1 may be based on CSI Reporting #0 configuration, and may correspond to different structure hypotheses included in CSI Reporting #0, respectively.

Through at least some of the operations, the base station may acquire the CSI report based on the configuration of the single CSI resource/resource set and the single CSI report. That is, the base station may acquire the CSI report corresponding to the configuration of the single CSI resource/resource set and the single CSI report.

In method 3, the base station may configure a CSI report for determining SD adaptation through configuration 1 below. This may be for energy saving.

### Configuration 1

In configuration 1, the base station may perform a method for configuring, to an RRC-connected terminal, CSI report configuration information for determining SD adaptation to save energy.

The base station may configure, for the terminal, CSI report configuration information for determining SD adaptation. For example, this may be configured for an RRC connected/inactive terminal for energy saving of the base station.

For example, CodebookConfig of CSI-reportConfig may be configured via RRC signaling as shown in Table 13 below.

```
TABLE 13
CodebookConfig ::= SEQUENCE {
CodebookConfig-r18 ::= SEQUENCE {
  AdaptationType CHOICE {Type 1, Type 2},
Active_duration INTEGER (1..31),
NES-Threshold CHOICE {rsrp-Threshold, CQI index},
Type2-SD-Adaptation {
    PowerControlOffsetSS ENUMERATED {db−3, db0, db3, db6},
typeII-r16 SEQUENCE {
Multi-n1-n2-codebookSubsetRestriction-r16 ENUMERATED {
two-one BIT STRING (SIZE (16)),
two-two BIT STRING (SIZE (43)),
four-one BIT STRING (SIZE (32)),
three-two BIT STRING (SIZE (59)),
...
},
Nrofmulti-n1-n2-codebook ENUMERATED {1, 2, 3, 4},...
}
...
```

The base station may configure, through CodebookConfig RRC configuration, a CSI report having multiple antenna structure hypotheses of the base station for SD adaptation during an NES mode. In this case, as new information, at least some of information on the type of SD adaptation, active_duration information to which measurement is applied based on the multiple antenna structure hypotheses, NES-Threshold for determining an antenna structure selected from the multiple antenna structure hypotheses, a PowerControlOffsetSS value, or the number Nrofmulti-n1-n2-codebook of CSI reports which can be transmitted through CSI reporting among the multiple antenna structure hypotheses may be configured. The RRC value may be variously configured, for example.

Through the above-described methods or embodiments, energy consumption of the base station can be reduced.

Herein, to reduce energy consumption of the base station and apply SD adaptation and PD adaptation during the SD adaptation and PD adaptation, a method for determining a priority for each CSI report when receiving multiple pieces of CSI feedback from the terminal may be provided. In addition, a method for multiplexing multiple CSI reports to a PUCCH/PUSCH is disclosed. The base station may receive multiple CSI reports during the SD adaptation and/or PD adaptation for energy saving, and energy of the base station can be saved accordingly.

### First Embodiment

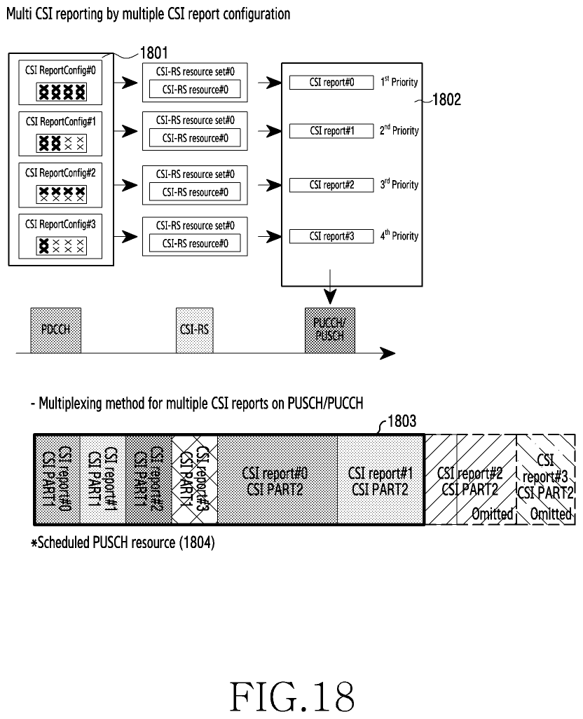

FIG. 18 illustrates an operation of transmitting multiple CSI reports by a base station and a terminal according to an embodiment.

Referring to FIG. 18, a Release-15/16/17 base station may receive multiple CSI reports from the terminal through multiple CSI-ReportConfigs having codebook configurations corresponding to multiple space domain (SD) patterns, respectively.

The base station may configure, for the terminal through higher-layer signaling, CSI-ReportConfig according to each of the multiple spatial adaptation patterns (1801), may configure the multiple CSI reports for the terminal through higher-layer signaling and L1 signaling (1802). In this case, priority values of the configured CSI reports may be determined through Equation (2) below of determining a priority (Pri) value

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 2 )$$

In Equation (2), y=0 in aperiodic CS reports, y=1 in semi-persistent CSI reports on PUSCH, y=2 in semi-persistent CSI reports on PUCCH, and y=3 in periodic CSI reports.

k=0 in CSI reports including L1-RSRP or L1-SINR, and k=0 in other cases.

c indicates a serving cell index, and N_{cells} indicates a value configured for a higher-layer parameter of maxNrofServingCells.
s indicates reportConfigID, and Ms is a value for a higher-layer parameter of maxNrofCSI-ReportConfigurations.

In Equation (2), the respective CSI reports may have different priority values (1802). Thereafter, the CSI reports may be multiplexed in a PUSCH according to a configured priority value (1803). In this case, CSI report part 1 (i.e., CRI, RI, and CQI for 1^{st} codeword) of the multiple CSI reports is first multiplexed, and then CSI report part 2 (i.e., PMI, L1, and CQI for 2^{nd} codeword) may be multiplexed in a descending order of the CSI reports. In this case, as in Equation (3) below, when the amount of resource required for transmission of CSI report part 2 is less than the amount of remaining resource of the PUSCH, omission may occur from CSI report part 2 having a lower priority.

$$[ \frac{( {O}_{CSI - 2} + {L}_{CSI - 2} ) \cdot {β}_{offset}^{PUSCG} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCH} - 1} {M}_{SC}^{UCI} ( l ) ] - {Q}_{\frac{ACK}{CG} - UCI}^{′} - {Q}_{CSI - 1}^{′} \qquad ( 3 )$$

Equation (3) is a calculation formula of a coded modulation symbol per layer for CSI part 2 multiplexed in the PUSCH in PUSCH repetition transmission type B including a UL-SCH, O_{CSI-2} and L_{CSI-2} may indicate the number of bits for CSI part 2 and the number of CRC bits for CSI part 2, respectively. β_{offset}^{PUSCG} may be identical to β_{offset}^{CSI-part2} which indicates a beta offset for CSI part 2. C_{UL-SCH} indicates the number of codeblocks of the UL-SCH for PUSCH transmission, Kᵣ indicates a codeblock size of the r^{th} codeblock. M_{SC}^{UCI}(l) indicates the number of resource elements which can be used for UCI transmission in symbol l, and the number is determined according to whether there are a DMRS and a PTRS of symbol l. If a DRMS is included in symbol l, M_{SC}^{UCI}(l)=0. If the DMRS is not include in symbol l, M_{SC}^{UCI}(l)=M_{SC}^{PUSCH}−M_{SC}^{PT-RS}(l). M_{SC}^{PUSCH} is the number of subcarriers for a bandwidth in which PUSCH transmission is scheduled, M_{SC}^{PT-RS}(l) is the number of subcarriers including the PTRS within symbol l. N_{symb,all}^{PUSCH} indicates a total number of symbols of the PUSCH. α is scaling of a higher-layer parameter, and indicates a ratio of a resource to which UCI can be multiplexed among all resources for PUSCH transmission.

In Equation (3), among the multiple CSI reports, CSI report part 1 may be multiplexed first, and then CSI report part 2 may be multiplexed.

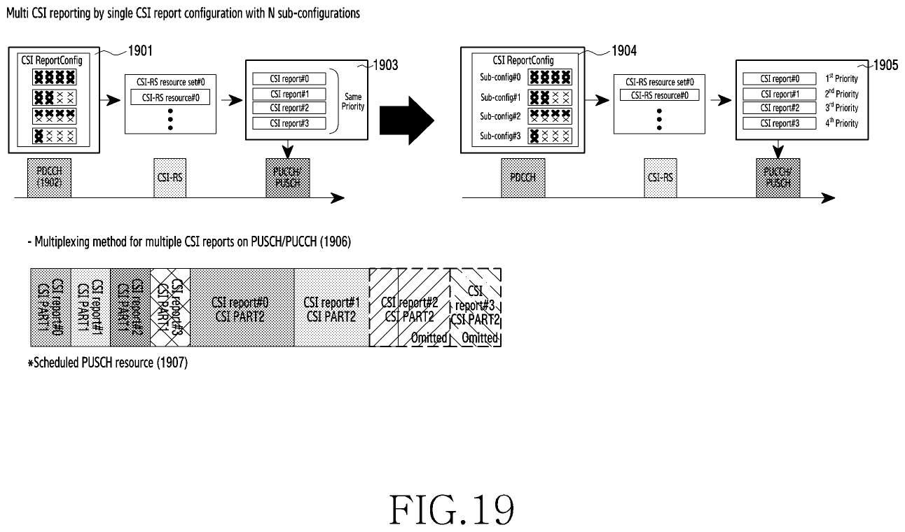

FIG. 19 illustrates an example of describing an operation of transmitting multiple CSI reports by a base station and a terminal for energy saving of the base station according to an embodiment.

Referring to FIG. 19, for energy saving of the base station, a CSI report configuration having L sub-configurations (e.g., multiple codebook configurations) corresponding to SD patterns (1901). Thereafter, for energy saving, the base station may indicate, to the terminal via a MAC CE or DCI, a CSI report for N sub-configurations for applying SD or PD adaptation (1902). In this case, when Equation (1) is applied, N CSI reports obtained through the N sub-configurations may be configured to have the same priority value (1903). In this case, for multiplexing according to the priority, the priority may be determined in one of the methods below or a combination thereof.

### Method 7

In Method 7, the base station may configure an index for a sub-configuration for each sub-configuration (1904), and may determine the priority according to the sub-configuration index. More specifically, the base station may determine the priority value by using the Pri_{iCSI} value and the sub-configuration index as in Equations (4), (5), (6) and (7) below.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + {i}_{sub - config} \qquad ( 4 )$$

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + {M}_{sub - config} * {i}_{sub - config} \qquad ( 5 )$$

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + div ( {i}_{sub - config} , {M}_{sub - config} ) \qquad ( 6 )$$

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + mode ( {i}_{sub - config} , {M}_{sub - config} ) \qquad ( 7 )$$

In Equations (4), (5), (6) and (7) above, CSI reports having different priorities may be obtained. In this case, M_{sub-config} indicates maxNrofsub-Configurations (e.g., L: a total number of sub-configurations in a CSI reportConfig), and i_{sub-config} indicates a sub-configuration index. If a CSI report (e.g., a CSI report configured via CSI-reportConfig when N=1 or L=1) for NES and a CSI report (e.g., a CSI report configured via CSI-reportConfig when N=1 or L=1) for a normal operation are overlapped with each other, the base station and terminal may first multiplex the NES CSI report, or may drop the CSI report for the normal operation. In addition, by applying the priority value obtained by the method above, the NES CSI report and the CSI report of the normal mode may be multiplexed. As another method, the base station and the terminal may drop the NES CSI report, or may be multiplexed with a lower priority. After the above operations are first determined, then N CSI reports including N sub-configurations may be multiplexed according to the priorities. In this case, an overlapping rule between the CSI reports of the NES and the normal mode may be determined according to a specific capability or a mode configured by the base station.

Through the method of the disclosure, the base station and the terminal may determine the priorities of N CSI reports obtained through the N sub-configurations (1905). Thereafter, multiplexing may be performed according to the priority rule (1906).

### Method 8

In Method 8, the base station may determine the priorities according to the number of ports configured for each sub-configuration. More specifically, the base station may determine the priority value by using the number of ports of the sub-configuration and the Pri_{iCSI} value as shown in Equations (8) and (9) below.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + {i}_{nroports} \qquad ( 8 )$$

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + {M}_{sub - config} * {i}_{nrofports} \qquad ( 9 )$$

In Equations (8) and (9) above, different priorities between the sub-configurations may be determined, and the terminal may determine that the priority is high when N1 is greater between (N1, N2) configured in codebookConfig, or determine the priority according to N2 if i_{nrofports} is configured with the same value through a codebook configuration. In addition, in (Ng, N1, and N2) via multi-panel configuration, the terminal may prioritize an Ng value and determine the priority. When there is overlapping with the CSI report of the normal mode, based on the priority determined according to Equations (8) and (9) above, operation may be performed as in the method described in Method 7.

The priority value equation obtained through Methods 7 and 8 may be applied only to the CSI report for reporting N CSIs for NES. Thereafter, the CSI report may be multiplexed, based on the priority value, to the PUSCH. In addition, when a PUSCH including an SP CSI report for NES and a PUSCH for data transmission are overlapped with each other, the PUSCH including the SP CSI report may be transmitted, and the PUSCH for data transmission may be dropped, or the SP CSI report may be multiplexed with the PUSCH for data transmission.

### Second Embodiment

In the second embodiment, a new multiplexing method for transmitting, by a base station, multiple CSI reports according to SD patterns for applying or while applying SD adaptation and PD adaptation for energy saving is proposed. When a PMI/TPMI and an MCS for data transmission are determined by using the CSI report for NES, the CSI report for NES may need to include at least one PMI. In addition, when the NES CSI report and the CSI report of the normal mode overlap with each other, using the priority rule of the first embodiment, the new multiplexing method is disclosed.

The N CSI reports corresponding to the N sub-configurations for energy saving of the base station may be multiplexed with the PUSCH through one of the methods or a combination thereof.

### Method 9

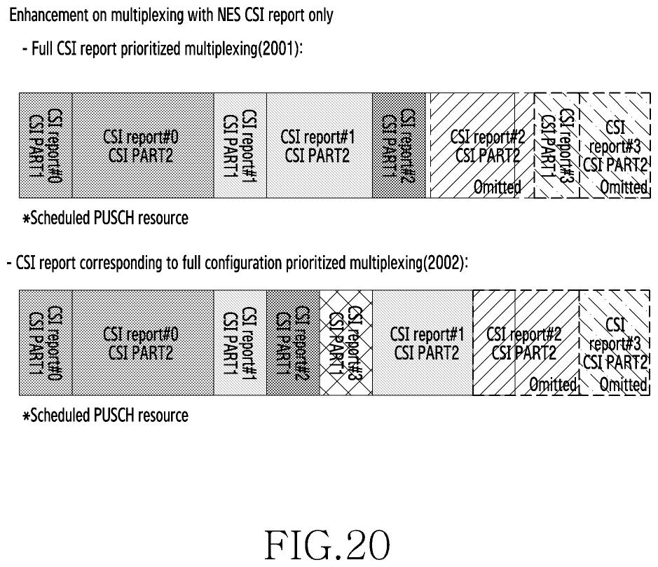

FIG. 20 illustrates a method for multiplexing multiple CSI reports by a terminal according to an embodiment.

Referring to FIG. 20, for energy saving of the base station, the base station may indicate to transmit N CSI reports through CSI-reportConfig having N sub-configurations corresponding to multiple SD patterns. Thereafter, the priorities of the respective N CSI reports may be determined through the method of the first embodiment. Thereafter, the terminal may sequentially multiplex the full CSI report, based on the priorities (2001). In CSI reports #2 and #3 exceeding the configured PUSCH resource, the entire CSI report #3 may be omitted, or CSI report part 2 corresponding to a part of CSI report #2 may be dropped. In this case, a condition for determining omission may be represented as in Equation (10) below.

$$[ \frac{( {O}_{CSI , n} + {L}_{CSI , n} ) \cdot {β}_{offset}^{PUSCG} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCH} - 1} {M}_{SC}^{UCI} ( l ) ] - {Q}_{\frac{ACK}{CG} - UCI}^{′} - {\sum }_{k = 0}^{n - 1} {Q}_{CSI , k}^{′} \qquad ( 10 )$$

In Equation (10), the terminal may determine a CSI report to be omitted, and then may apply Equation (11) below to multiplex a part of part 1 or part 2 of the CSI report.

$$[ \frac{( {O}_{CSI - 1 , n} + {L}_{CSI - 1 , n} ) \cdot {β}_{offset}^{PUSCG} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ] is less than or equal to [ α \cdot {\sum }_{l = 0}^{{N}_{symb , all}^{PUSCH} - 1} {M}_{SC}^{UCI} ( l ) ] - {Q}_{ACK / CG - UCI}^{′} - {\sum }_{k = 0}^{n - 1} {Q}_{CSI , k}^{′} \qquad ( 11 )$$

When Equation (11) is satisfied, CSI report part 1 may be transmitted. In Equation (11), in (2001) of FIG. 20, the entire CSI report #3 may be omitted, and only CSI report part 2 of CSI report #2 may be omitted. In Equation (10), O_{CSI,n} and L_{CSI,n} are the number of bits in consideration of both part 1 and part 2 of the CSI report having the n^{th} priority and the number of CRC bits of the corresponding CSI report, respectively. Q′_{CSI,k} is the amount of resource for multiplexing of the CSI report having the kth priority. In Equation (11), O_{CSI-2,n} and L_{CSI-2,n} indicate the number of bits for part 2 of the CSI report having the n^{th} priority. Through this, the full CSI report-based multiplexing method may be applied to the NES CSI report.

### Method 10

FIG. 20 illustrates an example of describing a method for multiplexing multiple CSI reports by a terminal according to an embodiment.

Referring to FIG. 20, for energy saving of the base station, the base station may indicate to transmit N CSI reports through CSI-reportConfig having N sub-configurations corresponding to multiple SD patterns. Thereafter, the priorities of the respective N CSI reports may be determined through the method of the first embodiment. Thereafter, the terminal may first multiplex the CSI report having the highest priority, and then apply the existing multiplexing method (2002). In CSI report #2 and #3 exceeding the configured PUSCH resource, a part or all of the CSI report may be dropped. In this case, a condition for determining omission may be represented as in Equation (12) below.

$$[ \frac{( {O}_{CSI - 1} + {L}_{CSI - 1} ) \cdot {β}_{offset}^{PUSCG} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCH} - 1} {M}_{SC}^{UCI} ( l ) ] - {Q}_{ACK / CG - UCI}^{′} - {Q}_{CSI , 1 st}^{′} \qquad ( 12 )$$

In Equation (12), the terminal may multiplex the CSI report having the highest priority and then determine whether to omit CSI report part 1 and part 2. Thereafter, if all CSI part 1 is all transmitted, Equation (13) below may be applied to determine the omission of part 2 of the CSI report.

$$[ \frac{( {O}_{CSI - 2} + {L}_{CSI - 2} ) \cdot {β}_{offset}^{PUSCG} \cdot {\sum }_{l = 0}^{{N}_{symb , all}^{PUSCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCH} - 1} {M}_{SC}^{UCI} ( l ) ] - {Q}_{ACK / CG - UCI}^{′} - {Q}_{CSI , 1 st}^{′} - {Q}_{CSI - 1}^{′} \qquad ( 13 )$$

In Equation (13), omission of part 2 of the CSI report may be determined, level by level of the priority. In Equation (12) and Equation (13), Q′_{CSI,1st} is the amount of resource for the CSI report in consideration of both part 1 and part 2 of the CSI report having the highest priority. In general, the terminal may configure a PUSCH resource that is sufficient for the base station to transmit both the 1^{st} prioritized CSI report and CSI report part 1.

In methods 9 and 10, the terminal may multiplex NES CSI reports through a new method. In this case, the NES CSI report and the normal mode CSI report may not be multiplexed together as in the first embodiment. Whether the multiplexing is possible may be determined according to the capability of the terminal. A method for multiplexing the PUSCH described herein may be applied to the PUCCH also for the multiple CSI reports.

As described herein, the base station may provide a priority determination and multiplexing procedure for the CSI report for applying or while applying SD adaptation and PD adaptation for energy saving.

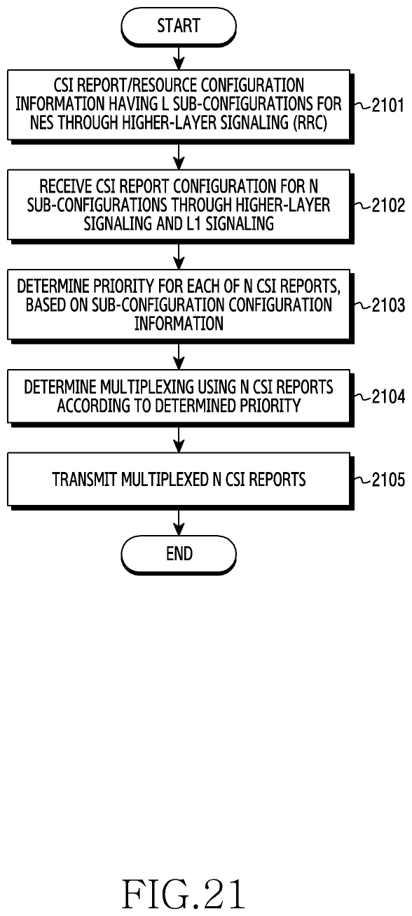

FIG. 21 illustrates a terminal to which an energy saving method of a wireless communication system is applied according to an embodiment.

In step 2101, the terminal may receive CSI report/resource configuration information having L sub-configurations through higher-layer signaling (RRC) for energy saving of the base station from the base station.

In step 2102, the terminal may receive a CSI report configuration for N sub-configurations through higher-layer signaling and L1 signaling.

In step 2103, the priorities of the respective N CSI reports may be determined based on the sub-configuration configuration information.

In step 2104, the terminal may perform multiplexing using N CSI reports based on the determined priority.

In step 2105, the terminal may transmit the multiplexed N CSI reports.

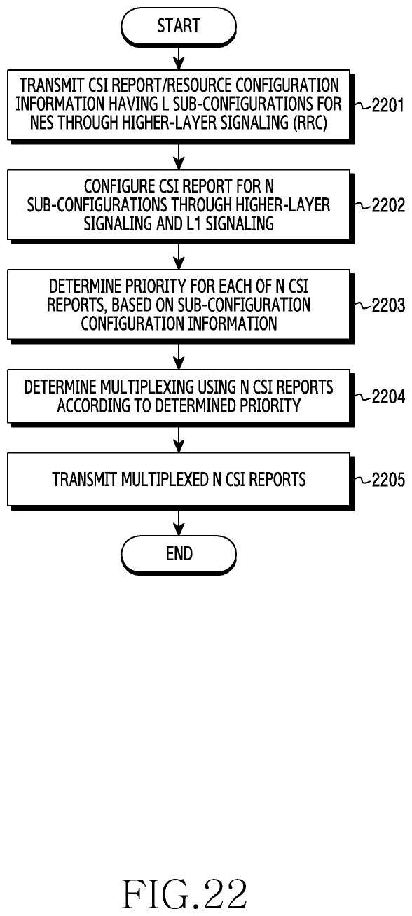

FIG. 22 illustrates a base station to which an energy saving method of a wireless communication system is applied according to an embodiment.

In step 2201, the base station may transmit, to the terminal, CSI report/resource configuration information having L sub-configurations through higher-layer signaling (RRC) for energy saving of the base station.

In step 2202, the base station may transmit, to the terminal, a CSI report configuration for N sub-configurations through higher-layer signaling and L1 signaling.

In step 2203, the priorities of the respective N CSI reports may be determined based on the sub-configuration configuration information.

In step 2204, the base station may determine multiplexing using N CSI reports based on the determined priority.

In step 2205, the base station may receive the multiplexed N CSI reports.

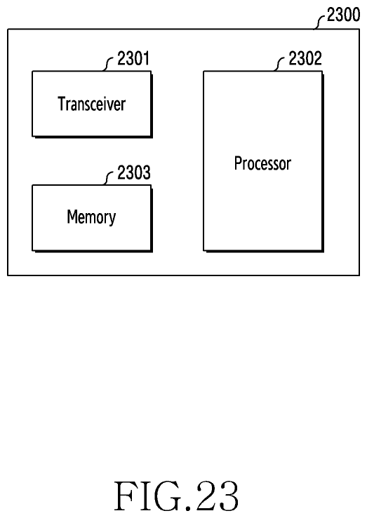

FIG. 23 illustrates a terminal according to an embodiment.

Referring to FIG. 23, a terminal 2300 may include a transceiver 2301, a controller (e.g., a processor) 2302, and a storage (e.g., memory) 2303. According to at least one of methods corresponding to the above-described embodiments or a combination thereof, the transceiver 2301, the controller 2302, and the storage 2303 of the terminal 2300 may operate. However, elements of the terminal 2300 are not limited to the illustrated examples, and the terminal 2300 may include more or fewer elements than those described above. The transceiver 2301, the controller 2302, and the storage 2303 may be implemented as one chip.

The transceiver 2301 may include a transmitter and a receiver. The transceiver 2301 may transmit or receive a signal to or from a base station. The signal may include control information and data. The transceiver 2310 may include a RF transmitter for up-converting and amplifying a frequency of a transmitted signal, and an RF receiver for low-noise-amplifying and down-converting a frequency of a received signal. The transceiver 2301 may receive a signal via a wireless channel and output the signal to the controller 2302, and transmit a signal output from the controller 2302 via a wireless channel.

The controller 2302 may control a series of procedures in which the terminal 2300 may operate according to the above-described embodiment. For example, the controller 2302 may perform or control the operation of the terminal for performing at least one of the method according to the embodiments of the disclosure or a combination thereof. The controller 2302 may include at least one processor. For example, the controller 2302 may include a communication processor (CP) for performing control for communication and an application processor (AP) for controlling a higher layer (e.g., application).

The storage 2303 may store control information (e.g., information related to channel estimation, generated using DMRSs transmitted in the PUSCH included in a signal acquired from the terminal 2300) or data, and may have an area for storing data necessary for controlling by the controller 2302 and data generated when the controller 2302 performs control.

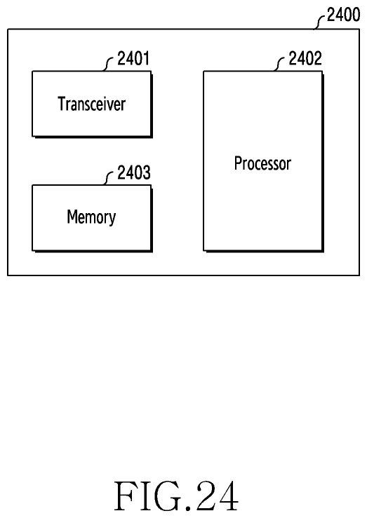

FIG. 24 illustrates a base station according to an embodiment.

Referring to FIG. 24, a base station 2400 may include a transceiver 2401, a controller (e.g., a processor) 2402, and a storage (e.g., memory) 2403. According to at least one of the above methods, the transceiver 2401, the controller 2402, and the storage 2403 of the base station 2400 may operate. However, elements of the base station 2400 are not limited to the illustrated examples. The base station 2400 may include more or fewer elements than those described above. The transceiver 2401, the controller 2402, and the storage 2403 may be implemented as one chip.

The transceiver 2401 may include a transmitter and a receiver according to an embodiment. The transceiver 2401 may transmit or receive a signal to or from a terminal. The signal may include control information and data. The transceiver 2401 may include an RF transmitter for up-converting and amplifying a frequency of a transmitted signal, and an RF receiver for low-noise-amplifying and down-converting a frequency of a received signal. The transceiver 2401 may receive a signal via a wireless channel and output the signal to the controller 2402, and transmit a signal output from the controller 2402 via a wireless channel.

The controller 2402 may control a series of procedures so that the base station 2400 may operate according to the above-described embodiment. For example, the controller 2402 may perform or control the operation of the base station for performing at least one of the above methods. The controller 2402 may include at least one processor. For example, the controller 2402 may include a CP for performing control for communication and an AP for controlling a higher layer (e.g., application).

The storage 2403 may store control information (e.g., information related to channel estimation, generated using DMRSs transmitted in the PUSCH determined by the base station 2400), data, and control information or data received from the terminal, and may have an area for storing data necessary for controlling by the controller 2402 and data generated when the controller 2402 performs control.

### Third Embodiment

In the third embodiment, a new multiplexing method for transmitting multiple CSI reports according to SD patterns to apply or while applying SD adaptation and PD adaptation for energy saving by the base station is disclosed. In addition, a priority rule between the existing CSI report (e.g., non-NES CSI report) of the normal operation and the NES CSI report is provided, and then a dropping/omission rule of the NES CSI report during multiplexing of the UL resource (PUSCH or PUCCH) is provided. More specifically, the priority rule between the existing CSI report (e.g., non-NES CSI report) of the normal operation and the NES CSI report may be determined as follows.

### Method 11

In method 11, the base station may always prioritize only the CSI report of the normal operation when determining the priority between the existing CSI report (e.g., non-NES CSI report) of the normal operation and the NES CSI report. However, the base station may prioritize only the NES CSI report. Thereafter, the priorities between the CSIs acquired through multiple sub-configurations of the NES CSI report may be defined as in Equations (14) and (15) below.

$${Pri}_{iCSI} ( y , k , c , s ) = {M}_{sub - config} \cdot ( 2 \cdot {N}_{cells} \cdot {M}_{s} \cdot y + {N}_{cells} \cdot {M}_{s} \cdot k + {M}_{s} \cdot c + s ) + {i}_{sub - config} \qquad ( 14 )$$

In Equation (14), y=0 in aperiodic CS reports, y=1 in semi-persistent CSI reports on PUSCH, y=2 in semi-persistent CSI reports on PUCCH, and y=3 in periodic CSI reports.
k=0 in CSI reports including L1-RSRP or L1-SINR, and otherwise, k=0.
c indicates a serving cell index, and N_{cells} is a value configured as a higher-layer parameter of maxNrofServingCells.
s indicates reportConfigID, and Ms is a value configured as a higher-layer parameter of maxNrofCSI-ReportConfigurations.
M_{sub-config} is a value configured as maxNrofsub-Configurations (e.g., L: total number of sub-configurations in a CSI reportConfig)
i_{sub-config} is a value of sub-configuration index.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + {i}_{sub - config} \qquad ( 15 )$$

In Equation (15), y=0 in aperiodic CS reports, y=1 in semi-persistent CSI reports on PUSCH, y=2 in semi-persistent CSI reports on PUCCH, and y=3 in periodic CSI reports. y=4 in CSI reporting with N sub-configuration on PUSCH, and y=5 in CSI reporting with N sub-configuration on PUCCH.
k=0 in CSI reports including L1-RSRP or L1-SINR, and otherwise, k=0.
c indicates a serving cell index, and N_{cells} is a value configured as a higher-layer parameter of maxNrofServingCells.
s indicates reportConfigID, and Ms is a value configured as a higher-layer parameter of maxNrofCSI-ReportConfigurations.
i_{sub-config} is a value of sub-configuration index.

In Equations (14) and (15), the priorities between the CSIs corresponding to multiple sub-configurations may be determined. In this case, as a simpler method, when determining the priorities between the existing CSI report (e.g., non-NES CSI report) of the normal operation and the NES CSI report, the base station may always prioritize only the CSI report of the normal operation for one purpose, and then may determine the priority while having sub-configuration granularity through 2 steps by using the index of the sub-configuration in the CSI report for a single NES.

Thereafter, the base station may determine a CSI dropping/omitting rule of the CSI report, based on the determined priority information. In this case, when the existing CSI report (e.g., non-NES CSI report) of the normal operation and the NES CSI report overlap with each other, the existing multiplexing method may be reused. Thereafter, a dropping rule for each sub-configuration for the NES CSI report may be newly applied as follows.

If the NES CSI report is transmitted in the structure of the single part CSI, all of the CSIs corresponding to the sub-configuration may be omitted or transmitted without applying the omitting rule.

When the NES CSI report is transmitted in the structure of two part CSI, the dropping rule between CSIs corresponding to sub-configuration may be applied.

In this case, as described in the scheduled PUSCH resource 1804 of FIG. 18, CSI part 1 of the sub-configurations is always transmitted first, and then a level-by-level CSI part 2 dropping rule according the UL resource may be applied. To this end, new priority reporting levels for Part 2 CSI of sub-configuration may be defined as shown in Table 14 below. Alternatively, a configuration of a sub-configuration level may be added to the existing priority rule table.

```
TABLE 14
  Priority 0:
  For CSI reports 1 to N_{sub}, Group 0 CSI for CSI report configured multiple sub-
configurations in a CSI-reportConfig; Part 2 wideband CSI for CSIs configured
otherwise
  Priority 1:Group 1 CSI for CSI report 1, if for CSI report configured multiple
sub-configurations in a CSI-reportConfig; Part 2 subband CSI of even subbands for
CSIs, if configured otherwise
  Priority 2:Group 1 CSI for CSI report 1, if for CSI report configured multiple
sub-configurations in a CSI-reportConfig; Part 2 subband CSI of odd subbands for CSIs,
if configured otherwise
  ...
  Priority 2N_{sub} − 1:
  Group 1 CSI for CSI report N_{sub}, if for CSI report configured multiple sub-
configurations in a CSI-reportConfig; Part 2 subband CSI of even subbands for CSI of
N_{sub} sub-configuration, if configured otherwise
  Priority 2N_{sub} − 1:
  Group 1 CSI for CSI report N_{sub}_{_{Rep}}, if for CSI report configured multiple sub-
configurations in a CSI-reportConfig; Part 2 subband CSI of even subbands for CSI of
N_{sub} sub-configuration, if configured otherwise
```

Thereafter, the terminal may apply the multiplexing method in consideration of the UL resource and the CSI size, based on the priority rule. In Equation (16) below, part 2 CSI may be omitted.

$$[ \frac{( {O}_{CSI - 2 , n} + {L}_{CSI - 2 , n} ) \cdot {β}_{offset}^{PUSCG} \cdot {\sum }_{l = 0}^{{N}_{symb , all}^{PUSCHorPUCCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCHorPUCCH} - 1} {M}_{SC}^{UCI} ( l ) ] - {Q}_{ACK / CG - UCI} - {Q}_{CSI - 1} - {\sum }_{k = 0}^{n - 1} {Q}_{CSI - 2 , k} \qquad ( 16 )$$

As another method, as described in the full CSI report 2001 multiplexed based on the priority in FIG. 20, all CSIs of the sub-configuration may be dropped level by level according to the UL resource. In Equitation (17) below, all CSIs of the sub-configuration may be omitted.

$$[ \frac{( {O}_{CSI , n} + {L}_{CSI , n} ) \cdot {β}_{offset}^{PUSCG} \cdot {\sum }_{l = 0}^{{N}_{symb , all}^{PUSCHorPUCCH} - 1} {M}_{SC}^{UCI} ( l )}{{\sum }_{r = 0}^{{C}_{UL - SCH} - 1} {K}_{r}} ] is larger than [ α \cdot {\sum }_{l = 0}^{{N}_{symb , all}^{PUSCHorPUCCH} - 1} {M}_{SC}^{UCI} ( l ) ] - {Q}_{ACK / CG - UCI} - {\sum }_{k = 0}^{n - 1} {Q}_{CSI , k} \qquad ( 17 )$$

In Equations (16) and (17) above, n may vary according to whether the existing CSI report (e.g. non-NES CSI report) and the NES CSI report are multiplexed. If only the NES CSI report is multiplexed, n may be configured to be a priority value for each sub-configuration, and when the existing CSI report (e.g., non-NES CSI report) and the NES CSI report are multiplexed, n may be a value in consideration of the priorities between the existing CSI report (e.g., non-NES CSI report) and the NES CSI report.

As described herein, when determining the priorities between the existing CSI report (e.g., non-NES CSI report) of the normal operation and the NES CSI report, only the CSI report of the normal operation may be always prioritized. However, only the NES CSI report may be prioritized. Thereafter, CSIs acquired through multiple sub-configurations of the NES CSI report may be multiplexed with the priorities and then transmitted.

The Equations described herein are examples, and the disclosure is not limited thereto. For example, in Equation (3), y=0 in CSI reporting with N sub-configuration on PUSCH, y=1 in, CSI reporting with N sub-configuration on PUCCH, y=2 in aperiodic CSI reports, y=3 in semi-persistent CSI reports on PUSCH, y=4 in semi-persistent CSI reports on PUCCH, and y=5 in periodic CSI reports. In addition, the existing CSI report of the normal operation and the NES CSI report may not be multiplexed together. Based on the method described above, the priority rule and the multiplexing method for the NES CSI reporting may be applied so that the base station determines an SD pattern for energy saving.

Herein, it is understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create indicates for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction indicates that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

What is claimed is:

1. A method performed by a user equipment (UE) in a wireless communication system, the method comprising:
receiving, from a base station (BS), configuration information for a channel state information (CSI) report, the configuration information including a plurality of sub-configurations;
generating the CSI report by omitting a part of the CSI report at a sub-configuration level within a same priority level, based on a plurality of indexes of the plurality of sub-configurations; and
transmitting, to the BS, the CSI report.

2. The method of claim 1,
wherein a sub-configuration among the plurality of sub-configurations with a lower index value has a higher priority.

3. The method of claim 1,
wherein a priority level of the CSI report is identified based on parameters included in the configuration information.

4. The method of claim 1,
wherein the part of the CSI report includes part 2 CSI information.

5. The method of claim 1,
wherein the CSI report is transmitted on a physical uplink shared channel (PUSCH) or a physical uplink control channel (PUCCH).

6. A method performed by a base station (BS) in a wireless communication system, the method comprising:
transmitting, to a user equipment (UE), configuration information for a channel state information (CSI) report, the configuration information including a plurality of sub-configurations; and
receiving, from the UE, the CSI report,
wherein the CSI report is that a part of the CSI report is omitted at a sub-configuration level within the same priority level based on a plurality of indexes of a plurality of sub-configurations.

7. The method of claim 6,
wherein a sub-configuration among the plurality of sub-configurations with a lower index value has a higher priority.

8. The method of claim 6,
wherein a priority level of the CSI report is identified based on parameters included in the configuration information.

9. The method of claim 6,
wherein the part of the CSI report includes part 2 CSI information.

10. The method of claim 6,
wherein the CSI report is received on a physical uplink shared channel (PUSCH) or a physical uplink control channel (PUCCH).

11. A user equipment (UE) in a wireless communication system, the UE comprising:
a transceiver, and
a controller coupled with the transceiver and configured to:
receive, from a base station (BS), configuration information for a channel state information (CSI) report, the configuration information including a plurality of sub-configurations,
generate the CSI report by omitting a part of the CSI report at a sub-configuration level within a same priority level, based on a plurality of indexes of the plurality of sub-configurations, and
transmit, to the BS, the CSI report.

12. The UE of claim 11,
wherein a sub-configuration among the plurality of sub-configurations with a lower index value has a higher priority.

13. The UE of claim 11,
wherein a priority level of the CSI report is identified based on parameters included in the configuration information.

14. The UE of claim 11,
wherein the part of the CSI report includes part 2 CSI information.

15. The UE of claim 11,
wherein the CSI report is transmitted on a physical uplink shared channel (PUSCH) or a physical uplink control channel (PUCCH).

16. A base station (BS) in a wireless communication system, the BS comprising:
a transceiver, and
a controller coupled with the transceiver and configured to:
transmit, to a user equipment (UE), configuration information for a channel state information (CSI) report, the configuration information including a plurality of sub-configurations, and
receive, from the UE, the CSI report,
wherein the CSI report is that a part of the CSI report is omitted at a sub-configuration level within the same priority level based on a plurality of indexes of a plurality of sub-configurations.

17. The BS of claim 16,
wherein a sub-configuration among the plurality of sub-configurations with a lower index value has a higher priority.

18. The BS of claim 16,
wherein a priority level of the CSI report is identified based on parameters included in the configuration information.

19. The BS of claim 16,
wherein the part of the CSI report includes part 2 CSI information.

20. The BS of claim 16,
wherein the CSI report is received on a physical uplink shared channel (PUSCH) or a physical uplink control channel (PUCCH).
